(19) United States
(12) Patent Application Publication
(10) Pub. No.: US 2024/0048950 A1
(43) Pub. Date: Feb. 8, 2024

(54) SERVICE PROCESSING METHOD AND RELATED DEVICE

(71) Applicant: HUAWEI TECHNOLOGIES CO., LTD., SHENZHEN, GUANGDONG (CN)

(72) Inventors: Bin WANG, Xi’an (CN); Shuanqing DAI, Xi’an (CN); Guoqi YAN, Xi’an (CN); Xin ZHAO, Xi’an (CN)

(21) Appl. No.: 18/039,162

(22) PCT Filed: Nov. 29, 2021
(86) PCT No.: PCT/CN2021/133815

§ 371 Date: May 26, 2023

(30) Foreign Application Priority Data
Nov. 30, 2020 (CN) 202011380618.7

(51) Int. Cl. H04W 4/50; H04W 4/35; H04W 8/18

(52) U.S. Cl. CPC H04W 4/50; H04W 4/35; H04W 8/18; H04W 84/12

(57) ABSTRACT

The method includes: An electronic device registers with a server; broadcasts service information to one or more mobile terminals based on a preset broadcast distance; receives a service subscription request sent by the one or more mobile terminals; sends a first message to the server, where the first message includes the service subscription request, and the first message indicates the server to confirm the service subscription request; and receives a service request sent by the one or more mobile terminals, and sends a second message to the server based on the service request, where the second message indicates the server to perform service processing.

This application is a national stage of International Application No. PCT/CN2021/133815, filed on Nov. 29, 2021, which claims priority to Chinese Patent Application No. 202011380618.7 filed on Nov. 30, 2020. Both of the aforementioned applications are hereby incorporated by reference in their entireties.

### TECHNICAL FIELD

Embodiments of this application relate to the field of communication technologies, and in particular, to a service processing method and a related device.

### BACKGROUND

With rapid development of the mobile Internet and the Internet of Things, a user may complete various service processing by using various applications of a mobile terminal. Many services, for example, mobile payment, self-service, or data sharing, may be completed by using a near field communication (NFC) technology and a QR code scanning technology.

However, an NFC manner and a QR code manner are usually used for point-to-point communication. Therefore, when users perform ticket pickup or payment services in the foregoing manner, the users need to sequentially perform service processing in a queue, resulting in low service processing efficiency. For example, during peak hours, in a bus card swiping scenario with a large crowd, passengers sequentially swipes cards to get on the bus, resulting in crowd congestion and low efficiency.

### SUMMARY

Embodiments of this application provide a service processing method and a related device, to provide a manner of performing parallel processing on mobile services of a plurality of users.

According to a first aspect, an embodiment of this application provides a service processing method. The method includes:

An electronic device registers with a server. In some embodiments, the electronic device may be a device of a merchant, for example, may be a payee device or a ticket pickup device. The registration may be network access registration of the electronic device. For example, the electronic device may be registered with the server. In this way, the server may determine that the electronic device is an authorized device, so that processing may be performed when a service transaction of the electronic device is subsequently received.

The electronic device broadcasts service information to one or more mobile terminals based on a preset broadcast distance. In some embodiments, the broadcast distance may be preset, and the broadcast distance may be set according to Wi-Fi signal strength. For example, the broadcast distance may be set by adjusting the Wi-Fi signal strength.

The electronic device receives a service subscription request sent by the one or more mobile terminals, where the service subscription request is generated based on the service information. In some embodiments, each service subscription request is in a one-to-one correspondence with each mobile terminal. The service subscription request is for requesting to subscribe to a service from the electronic device. For example, a user may initiate a payment service or a ticket pickup service.

The electronic device sends a first message to the server, where the first message includes the service subscription request, and the first message indicates the server to confirm the service subscription request. In some embodiments, the first message may be a message including the service subscription request. In addition, the first message may further include information such as a user account and a mobile terminal device number. This is not limited in this embodiment of this application.

The electronic device receives a service request sent by the one or more mobile terminals, and sends a second message to the server based on the service request, where the second message indicates the server to perform service processing. In some embodiments, the second message may be a message including the service request. The service request may be a payment service request or a ticket pickup service request. The service processing may be processing of a payment service, for example, deduction. The service processing may be processing of a ticket pickup service, for example, ticket issuing.

In this embodiment, the service information is broadcast by the device of the merchant, and service requests of a plurality of users are processed simultaneously, so that service processing efficiency can be improved. This improves user experience.

In a possible implementation, before that the electronic device receives a service request sent by the one or more mobile terminals, the method further includes:

The electronic device receives a third message sent by the server, where the third message includes a subscription confirmation notification. In some embodiments, the subscription confirmation notification is for notifying the user that service subscription succeeds and the user can initiate the current service request.

The electronic device sends the subscription confirmation notification to the one or more mobile terminals.

In this embodiment, a service subscription notification is sent to the mobile terminal, so that only a user receiving a service confirmation notification can initiate a service request. In this way, an unauthorized user does not initiate a service request, so that service processing efficiency can be improved.

In a possible implementation, after that the electronic device sends a second message to the server based on the service request, the method further includes:

The electronic device receives a fourth message sent by the server, and gives a prompt based on the fourth message, where the fourth message includes a service processing completion notification. In some embodiments, the fourth message is for notifying the merchant that the service processing is completed. The prompt may include a subtitle, a voice, a vibration or the like. This is not limited in this embodiment of this application.

In this embodiment, the service processing completion notification is received and the prompt is given, so that the merchant can learn of a service processing status in real time. This improves merchant experience.

In a possible implementation, after that the electronic device receives a fourth message sent by the server, the method further includes:

The electronic device sends the service processing completion notification to the one or more mobile terminals.

In this embodiment, the service processing completion notification is received, and is forwarded to the user, so that the user can learn of a service processing result in real time. This improves user experience.

In a possible implementation, the service request includes ticket pickup information, and that the second message indicates the server to perform service processing includes:

The second message indicates the server to perform verification based on the ticket pickup information and perform the service processing based on a verification result. In some embodiments, the verification may include checking between the ticket pickup information and ticket booking information. For example, the ticket booking information may include a verification code that is delivered by the server and that is obtained when the user books a ticket. The verification code may include a digital code or a QR code. This is not limited in this embodiment of this application. The ticket pickup information may be a verification code entered by the user. After receiving the verification code sent by the user, the server may compare the verification code with a verification code in the ticket booking information stored in the server, to complete the verification. If the verification succeeds, the ticket may be issued; or if the verification fails, issuing of the ticket is rejected, and a failure message may be returned.

In some embodiments, ticket issuing information is carried in the service request, so that the server may perform the verification based on the ticket issuing information, and complete ticket issuing. This can improve service security.

In a possible implementation, after that the electronic device sends a second message to the server, the method further includes:

The electronic device receives a fourth message sent by the server, where the fourth message includes ticket issuing information; and issues a ticket based on the fourth message.

In this embodiment, the ticket is issued by receiving the ticket issuing information sent by the server. Because the ticket issuing information is verified by the server, security can be improved.

In a possible implementation, the electronic device is a payee device or a ticket pickup device.

An embodiment of this application further provides a service processing method, applied to a mobile terminal. The method includes:

The mobile terminal registers with a server. In some embodiments, the registration may include registration of a user account. It may be understood that the account may be related to a service enabled by a user, for example, a payment service or a ticket pickup service.

The mobile terminal enables a Wi-Fi function, and receives service information broadcast by an electronic device. In some embodiments, the user may enable the Wi-Fi function on the mobile terminal, to receive service information broadcast by a device of a merchant. The electronic device may be the device of the merchant, for example, may be a payee device or a ticket pickup device of the merchant.

The mobile terminal generates a service subscription request based on the service information, and sends the service subscription request to the electronic device, where the service subscription request indicates the server to confirm a service subscribed by the user. In some embodiments, the service subscription request may be related to the service subscribed by the user. For example, if the user expects to subscribe to a current payment service, the user may initiate a payment service subscription request; or if the user expects to subscribe to a current ticket pickup service, the user may initiate a ticket pickup service subscription request.

The mobile terminal sends a service request to the electronic device, where the service request indicates the server to perform service processing. In some embodiments, the mobile terminal may automatically initiate the service request to the device of the merchant, or may initiate the service request to the device of the merchant through a user operation. For example, the user may enter a transaction amount to initiate a current payment service request; or the user may enter a current ticket pickup verification code to initiate a current ticket pickup service request.

In this embodiment, any mobile terminal initiates service subscription and the service request to the device of the merchant. This can facilitate the user operation, and improve user experience, thereby improving service processing efficiency.

In a possible implementation, that the mobile terminal registers with a server includes:

The mobile terminal sends a first registration request to the server, where the first registration request includes a user account and payment information. The mobile terminal sends a payment service request to the server, where the payment service request is for requesting to enable a one-step payment function for the user account.

In this embodiment, the user enables the one-step payment function, so that the mobile terminal can automatically send the service request to the device of the merchant when initiating the service request. This can save the user operation, and improve user experience, thereby improving service processing efficiency.

In a possible implementation, that the service request indicates the server to perform service processing includes:

The service request indicates the server to complete payment based on information about the user account in the server. In some embodiments, because the user has completed one-step payment application, the server can complete automatic deduction based on the user account.

In this embodiment, the one-step payment function is enabled by the user, and automatic deduction is completed based on the user account, so that service processing efficiency can be improved.

In a possible implementation, that the mobile terminal registers with a server includes:

The mobile terminal sends a first registration request to the server, where the first registration request includes a user account and payment information.

In this embodiment, the user registers the account and the payment information with the server, so that the server can perform verification. This improves service security.

In a possible implementation, that the mobile terminal sends a service request to the electronic device, where the service request indicates the server to perform service processing includes:

The mobile terminal obtains payment confirmation information entered by the user. In some embodiments, the service confirmation information may include transaction information entered by the user, for example, information such as a transaction amount, a transaction password, and a transaction manner. It may be understood that the service confirmation information may further include other information. This is not limited in this embodiment of this application.

The mobile terminal sends the service request to the electronic device, where the service request includes the payment confirmation information, and the service request indicates the server to perform the service processing based on the payment confirmation information.

In this embodiment, the current service is completed by using the payment confirmation information entered by the user, so that autonomy of the user can be improved, and user experience can be improved.

In a possible implementation, that the mobile terminal sends a service request to the electronic device, where the service request indicates the server to perform service processing includes:

The mobile terminal obtains ticket pickup information entered by the user. In some embodiments, the ticket pickup information may include information such as a ticket pickup verification code. The verification code may include a digital code or a QR code, or may be a verification code in another form. This is not limited in this embodiment of this application. It may be understood that the ticket pickup information may be information obtained when the user books a ticket from the server.

The mobile terminal sends the service request to the electronic device, where the service request includes the ticket pickup information, and the service request indicates the server to perform the service processing based on the ticket pickup information. In some embodiments, the service processing may be verification performed based on the verification code.

In this embodiment, the user initiates a ticket pickup request to the server by entering the ticket pickup information such as the verification code. This can facilitate the user operation, and improve user experience.

In a possible implementation, before that the mobile terminal sends the service request to the electronic device, the method further includes:

The mobile terminal receives a subscription confirmation notification sent by the electronic device, where the subscription confirmation notification indicates the mobile terminal to send the service request.

In this embodiment, the subscription confirmation notification is received to initiate the service request. In this way, an unauthorized user does not initiate a service request, so that security can be improved.

In a possible implementation, after that the mobile terminal sends the service request to the electronic device, the method further includes:

The mobile terminal receives a service processing completion notification sent by the electronic device, where the service processing completion notification is for giving a prompt to the user that the service processing is completed.

In this embodiment, the service processing completion notification is received, so that the user can obtain a service processing result in real time. This can improve user experience.

According to a second aspect, an embodiment of this application provides a service processing apparatus, applied to an electronic device. The apparatus includes:
a registration module, configured to register, by the electronic device, with a server;
a broadcast module, configured to broadcast service information to one or more mobile terminals based on a preset broadcast distance;
a first sending module, configured to: receive a service subscription request sent by the one or more mobile terminals, where the service subscription request is generated based on the service information; and send a first message to the server, where the first message includes the service subscription request, and the first message indicates the server to confirm the service subscription request; and
a second sending module, configured to: receive a service request sent by the one or more mobile terminals; and send a second message to the server based on the service request, where the second message indicates the server to perform service processing.

In a possible implementation, the apparatus further includes:

a third sending module, configured to: receive a third message sent by the server, where the third message includes a subscription confirmation notification; and send the subscription confirmation notification to the one or more mobile terminals.

In a possible implementation, the apparatus further includes:

a prompting module, configured to: receive a fourth message sent by the server; and give a prompt based on the fourth message, where the fourth message includes a service processing completion notification.

In a possible implementation, the apparatus further includes:

a fourth sending module, configured to send the service processing completion notification to the one or more mobile terminals.

In a possible implementation, the service request includes ticket pickup information, and the second sending module is further configured to: the second message indicates the server to perform verification based on the ticket pickup information and perform the service processing based on a verification result.

In a possible implementation, the apparatus further includes:

a ticket issuing module, configured to: receive a fourth message sent by the server, where the fourth message includes ticket issuing information; and issue a ticket based on the fourth message.

In a possible implementation, the electronic device is a payee device or a ticket pickup device.

An embodiment of this application further provides a service processing apparatus, applied to a mobile terminal. The apparatus includes:
a registration module, configured to register, by the mobile terminal, with a server;
a first receiving module, configured to: enable, by the mobile terminal, a Wi-Fi function; and receive service information broadcast by an electronic device;
a first sending module, configured to: generate a service subscription request based on the service information; and send the service subscription request to the electronic device, where the service subscription request indicates the server to confirm a service subscribed by a user; and
a second sending module, configured to send a service request to the electronic device, where the service request indicates the server to perform service processing.

In a possible implementation, the registration module includes:
a first sending unit, configured to send, by the mobile terminal, a first registration request to the server, where the first registration request includes a user account and payment information; and
a second sending unit, configured to send, by the mobile terminal, a payment service request to the server, where the payment service request is for requesting to enable a one-step payment function for the user account.

In a possible implementation, the second sending module is further configured to: the service request indicates the server to complete payment based on information about the user account in the server.

In a possible implementation, the registration module includes:

a first sending unit, configured to send, by the mobile terminal, a first registration request to the server, where the first registration request includes a user account and payment information.

In a possible implementation, the second sending module is further configured to: obtain payment confirmation information entered by the user; and send the service request to the electronic device, where the service request includes the payment confirmation information, and the service request indicates the server to perform the service processing based on the payment confirmation information.

In a possible implementation, the second sending module is further configured to: obtain ticket pickup information entered by the user; and send the service request to the electronic device, where the service request includes the ticket pickup information, and the service request indicates the server to perform the service processing based on the ticket pickup information.

In a possible implementation, the apparatus further includes:

a second receiving module, configured to receive a subscription confirmation notification sent by the electronic device, where the subscription confirmation notification indicates the mobile terminal to send the service request.

In a possible implementation, the apparatus further includes:

a third receiving module, configured to receive a service processing completion notification sent by the electronic device, where the service processing completion notification is for giving a prompt to the user that the service processing is completed.

According to a third aspect, an embodiment of this application provides an electronic device. The device includes:
a memory, where the memory is configured to store computer program code; the computer program code includes instructions; and when the electronic device reads the instructions from the memory, the electronic device is enabled to perform the following operations:
registering, by the electronic device, with a server;
broadcasting service information to one or more mobile terminals based on a preset broadcast distance;
receiving a service subscription request sent by the one or more mobile terminals, where the service subscription request is generated based on the service information;
sending a first message to the server, where the first message includes the service subscription request, and the first message indicates the server to confirm the service subscription request; and
receiving a service request sent by the one or more mobile terminals, and sending a second message to the server based on the service request, where the second message indicates the server to perform service processing.

In a possible implementation, when the instructions are executed by the electronic device, the electronic device is enabled to further perform, before performing the operation of receiving a service request sent by the one or more mobile terminals, the following operations:
receiving a third message sent by the server, where the third message includes a subscription confirmation notification; and
sending the subscription confirmation notification to the one or more mobile terminals.

In a possible implementation, when the instructions are executed by the electronic device, the electronic device is enabled to further perform, after performing the operation of sending a second message to the server based on the service request, the following operation:

receiving a fourth message sent by the server, and giving a prompt based on the fourth message, where the fourth message includes a service processing completion notification.

In a possible implementation, when the instructions are executed by the electronic device, the electronic device is enabled to further perform, after performing the operation of receiving a fourth message sent by the server, the following operation:

sending the service processing completion notification to the one or more mobile terminals.

In a possible implementation, the service request includes ticket pickup information; and when the instructions are executed by the electronic device, the electronic device is enabled to perform the operation in which the second message indicates the server to perform service processing, where the operation includes:

the second message indicates the server to perform verification based on the ticket pickup information and perform the service processing based on a verification result.

In a possible implementation, when the instructions are executed by the electronic device, the electronic device is enabled to further perform, after performing the operation of sending a second message to the server, the following operations:
receiving a fourth message sent by the server, where the fourth message includes ticket issuing information; and
issuing a ticket based on the fourth message.

In a possible implementation, the electronic device is a payee device or a ticket pickup device.

An embodiment of this application further provides a mobile terminal. The terminal includes:
a memory, where the memory is configured to store computer program code; the computer program code includes instructions; and when the mobile terminal reads the instructions from the memory, the mobile terminal is enabled to perform the following operations:
registering, by the mobile terminal, with a server;
enabling, by the mobile terminal, a Wi-Fi function, and receiving service information broadcast by an electronic device;
generating a service subscription request based on the service information, and sending the service subscription request to the electronic device, where the service subscription request indicates the server to confirm a service subscribed by a user; and
sending a service request to the electronic device, where the service request indicates the server to perform service processing.

In a possible implementation, when the instructions are executed by the mobile terminal, the mobile terminal is enabled to perform the operation of registering, by the mobile terminal, with a server, where the operation includes:
sending, by the mobile terminal, a first registration request to the server, where the first registration request includes a user account and payment information; and
sending, by the mobile terminal, a payment service request to the server, where the payment service request is for requesting to enable a one-step payment function for the user account.

In a possible implementation, when the instructions are executed by the mobile terminal, the mobile terminal is enabled to perform the operation in which the service request indicates the server to perform service processing, where the operation includes:

the service request indicates the server to complete payment based on information about the user account in the server.

In a possible implementation, when the instructions are executed by the mobile terminal, the mobile terminal is enabled to perform the operation of registering, by the mobile terminal, with a server, where the operation includes:

the mobile terminal sends a first registration request to the server, where the first registration request includes a user account and payment information.

In a possible implementation, when the instructions are executed by the mobile terminal, the mobile terminal is enabled to perform the operation of sending a service request to the electronic device, where the service request indicates the server to perform service processing, where the operation includes:
obtaining payment confirmation information entered by the user; and
sending the service request to the electronic device, where the service request includes the payment confirmation information, and the service request indicates the server to perform the service processing based on the payment confirmation information.

In a possible implementation, when the instructions are executed by the mobile terminal, the mobile terminal is enabled to perform the operation of sending a service request to the electronic device, where the service request indicates the server to perform service processing, where the operation includes:
obtaining ticket pickup information entered by the user; and
sending the service request to the electronic device, where the service request includes the ticket pickup information, and the service request indicates the server to perform the service processing based on the ticket pickup information.

In a possible implementation, when the instructions are executed by the mobile terminal, the mobile terminal is enabled to further perform, before performing the operation of sending the service request to the electronic device, the following operation:

receiving a subscription confirmation notification sent by the electronic device, where the subscription confirmation notification indicates the mobile terminal to send the service request.

In a possible implementation, when the instructions are executed by the mobile terminal, the mobile terminal is enabled to further perform, after performing the operation of sending the service request to the electronic device, the following operation:

receiving a service processing completion notification sent by the electronic device, where the service processing completion notification is for giving a prompt to the user that the service processing is completed.

According to a fourth aspect, an embodiment of this application provides a computer-readable storage medium. The computer-readable storage medium stores a computer program. When the computer program is run on a computer, the computer is enabled to perform the method according to the first aspect.

According to a fifth aspect, an embodiment of this application provides a computer program. When the computer program is executed by a computer, the computer program is used to perform the method according to the first aspect.

In a possible design, the program in the fifth aspect may be all or partially stored in a storage medium encapsulated with the processor, or may be all or partially stored in a memory that is not packaged with the processor.

### BRIEF DESCRIPTION OF DRAWINGS

FIG. 1 is a diagram of an embodiment of a service processing method according to this application;

FIG. 2 is a flowchart of a service processing method according to this application;

FIG. 2A is a diagram of a Wi-Fi ultra-short distance mode of an electronic device according to an embodiment of this application;

FIG. 3 is a flowchart of a service processing method according to this application;

FIG. 4 is a flowchart of another service processing method according to this application;

FIG. 5 is a diagram of another embodiment of a service processing method according to this application;

FIG. 6 is a flowchart of another service processing method according to this application;

FIG. 7 is a diagram of a service processing apparatus according to this application;

FIG. 8 is a diagram of another service processing apparatus according to this application;

FIG. 9 is a diagram of an electronic device according to this application; and

FIG. 10 is a diagram of another electronic device according to this application.

### DESCRIPTION OF EMBODIMENTS

The following describes technical solutions in embodiments of this application with reference to the accompanying drawings in embodiments of this application. In descriptions of embodiments of this application, “I” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists.

The terms “first” and “second” mentioned below are merely intended for a purpose of description, and shall not be understood as an indication or implication of relative importance or implicit indication of a quantity of indicated technical features. Therefore, a feature limited by “first” or “second” may explicitly or implicitly include one or more features. In the descriptions of embodiments of this application, unless otherwise specified, “a plurality of” means two or more than two.

Currently, most mobile services can be implemented in an NFC manner or a QR code manner. The NFC manner has the following disadvantages: An NFC technology requires special hardware support, and implementation of the NFC technology needs to depend on an NFC chip, increasing production costs for an enterprise. In addition, the NFC technology is mainly used for point-to-point communication. Consequently, a plurality of mobile terminals cannot simultaneously complete mobile services, resulting in low efficiency. For example, during peak hours, users of a plurality of handheld mobile terminals can only complete payment in a queue, and cannot simultaneously complete payment. The QR code manner has the following disadvantages: A user needs to open a particular APP and show a QR code, to complete payment by scanning the QR code, resulting in a complex operation and poor user experience. In addition, users can only complete payment in a queue by scanning QR codes, and cannot simultaneously complete payment, resulting in low efficiency.

Based on the foregoing problem, embodiments of this application provide a service processing method, so that a plurality of mobile terminals can simultaneously complete payment without requiring complex operations of users. Therefore, service processing efficiency can be improved, and operation experience the users can be improved.

Embodiments of this application may be applied to a mobile terminal and a first electronic device. The mobile terminal may also be referred to as a terminal device, user equipment (UE), an access terminal, a subscriber unit, a subscriber station, a mobile station, a remote station, a remote terminal, a mobile device, a user terminal, a terminal, a wireless communication device, a user agent, or a user apparatus. The mobile terminal may be a cellular phone, a cordless phone, a personal digital assistant (PDA) device, a handheld device having a wireless communication function, a computing device, another processing device, a computer, a laptop computer, a handheld communication device, a handheld computing device, a satellite wireless device, or customer premises equipment CPE) connected to a wireless modem, and/or another device and a next-generation communication system configured to perform communication in a wireless system, for example, a mobile terminal in a 5G network or a mobile terminal in a future evolved public land mobile network (PLMN). The first electronic device may include a payee device or a ticket issuing device of a merchant. For example, the first electronic device may be a bus card reader, a ticket vending machine, or a self-service ticket pickup machine.

Some forms of the mobile terminal and the first electronic device that perform the technical solutions are not limited in embodiments of this application.

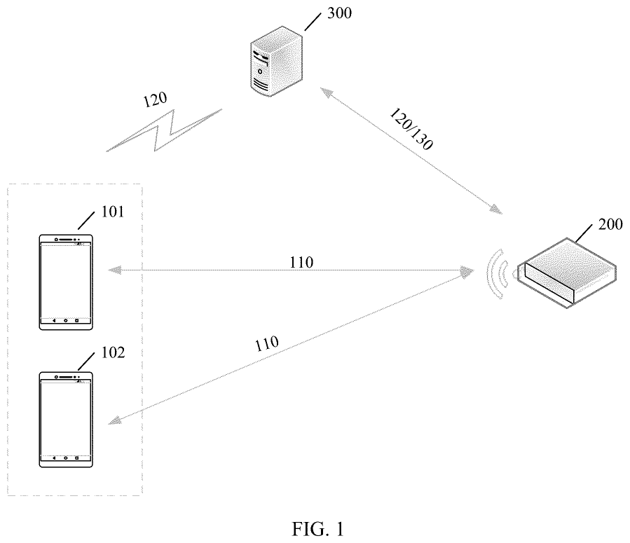

The service processing method provided in embodiments of this application is described with reference to FIG. 1 to FIG. 6.

FIG. 1 is an architectural diagram of an embodiment of an application scenario of a service processing method according to this application. The application scenario may be a mobile service scenario. A mobile service may include a payment service and a ticket pickup service. Refer to FIG. 1. A plurality of mobile terminals may simultaneously initiate mobile services to a first electronic device 200. For example, the first electronic device 200 may communicate with a mobile terminal 101 and a mobile terminal 102 by using a Wi-Fi ultra-short distance mode 110. It may be understood that only two mobile terminals are shown in the figure as an example. However, the first electronic device 200 may simultaneously communicate with more mobile terminals by using the Wi-Fi ultra-short distance mode 110. This is not limited. The mobile terminal 101 and the mobile terminal 102 may be devices for service interaction between users, for example, mobile phones. The first electronic device 200 may be a payee device or a ticket issuing device of a merchant, for example, a bus card reader, a ticket vending machine, or a self-service ticket pickup machine. The mobile terminal 101 and the mobile terminal 102 may communicate with a second electronic device 300 in a wireless manner 120. The second electronic device 300 may be a service server, and the service server may complete service authorization and verification for a user and a merchant device. The first electronic device 200 and the second electronic device 300 may communicate with each other in the wireless manner 120, or may communicate with each other in a wired manner 130. This is not limited in this embodiment of this application.

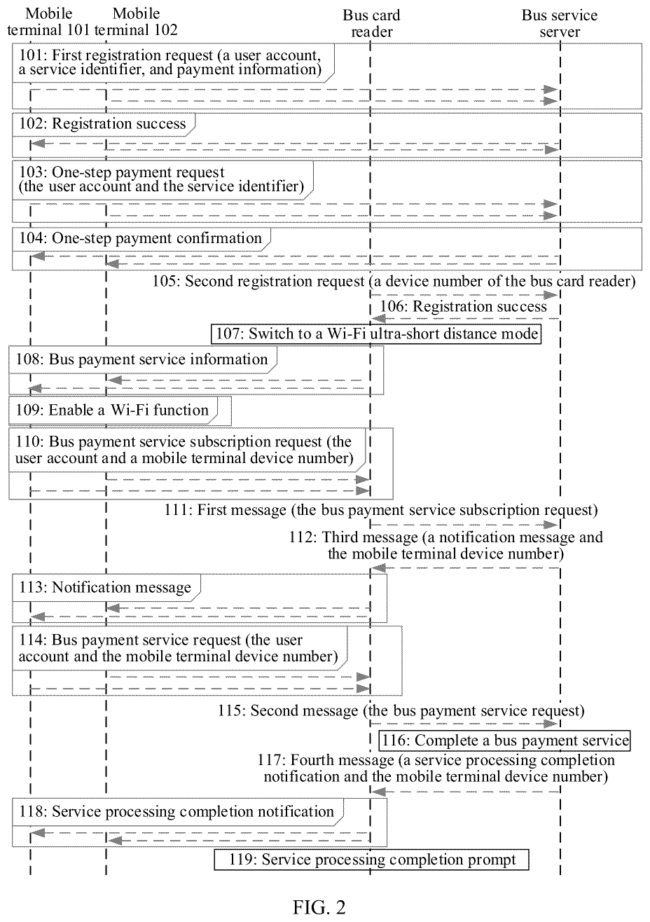

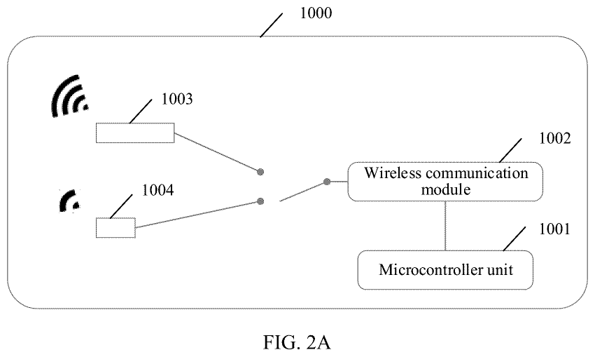

The following uses a bus mobile payment service scenario as an example for description. FIG. 2 is a schematic flowchart of an embodiment of a service processing method according to this application. The method may include the following operations.

Operation 101: One or more mobile terminals send a first registration request to a bus service server, to complete registration of a bus payment service of a user.

In some embodiments, the bus service server may be the second electronic device 300. If the user uses the bus payment service for the first time, the user needs to interact with the bus service server, to complete the registration of the bus payment service. In this way, the user can use the bus payment service through the mobile terminal, and the bus service server can process the bus payment service initiated by the mobile terminal. For example, the user may register a bus card automatic deduction service (the bus payment service) with the bus service server through the mobile terminal.

During implementation, the user may send the first registration request to the bus service server through the mobile terminal, to register the bus payment service with the bus service server. The first registration request includes a user account, a service identifier, and payment information. The user account is for identifying an identity of the user. The service identifier is for identifying the registered service. The payment information is for identifying a payment source of the user (where for example, the payment source may be a bus card, a payment platform, or a bank card, which is not limited in this embodiment of this application).

It may be understood that different users may register bus payment services with the bus service server through mobile terminals (for example, a mobile terminal 101 and a mobile terminal 102) of the users. Therefore, the one or more mobile terminals may simultaneously send the first registration request to the bus service server, to complete the registration of the bus payment service.

In some embodiments, after the user completes the registration of the bus payment service with the bus service server through the mobile terminal, the user may further enable a function of the bus payment service through the mobile terminal. For example, the user may set, in the mobile terminal, a state of a switching key of the bus payment service. If the switching key of the bus payment service is in an enabled state, the mobile terminal can use the bus payment service; or if the switching key of the bus payment service is in a disabled state, the mobile terminal cannot use the bus payment service.

Operation 102: The bus service server sends a registration success message to the one or more mobile terminals.

In some embodiments, after receiving the first registration request of the one or more mobile terminals, the bus service server may store the user account, the service identifier, and the payment information that are in the first registration request sent by the one or more mobile terminals, and send the registration success message to the one or more mobile terminals, so that the one or more mobile terminals can complete a task of registering the bus payment service with the bus service server.

It may be understood that the bus service server may simultaneously receive a plurality of first registration requests sent by a plurality of mobile terminals (for example, the mobile terminal 101 and the mobile terminal 102); and may sequentially send registration success messages to the plurality of mobile terminals after processing the plurality of first registration requests, or simultaneously send registration success messages to the plurality of mobile terminals after processing the plurality of first registration requests. This is not limited in this embodiment of this application.

Operation 103: The one or more mobile terminals initiate a one-step payment request to the bus service server.

In some embodiments, the user may further enable a one-step payment function based on the bus payment service. For example, the user may enable a one-step payment function option in an application of the bus payment service in the mobile terminal. In response to the operation of the user, the mobile terminal may initiate the one-step payment request to the bus service server, to enable the one-step payment function. The one-step payment request may include the user account and the service identifier. The one-step payment function may complete payment of the bus payment service without requiring the user to enter a password, for example, may complete one-step deduction when a bus card, a bank card, or a payment platform is used for payment. This can simplify the operation of the user, and improve operation experience of the user.

It may be understood that operation 103 and operation 101 may be performed simultaneously. For example, in operation 101, the first registration request may further carry information of the one-step payment request, so that request of one-step payment and registration of the bus payment service can be completed simultaneously. This is not limited in this embodiment of this application.

Operation 104: The bus service server sends a one-step payment confirmation to the one or more mobile terminals.

In some embodiments, after receiving the one-step payment request of the one or more mobile terminals, the bus service server may send the one-step payment confirmation to the one or more mobile terminals. In this way, the one-step payment function can be enabled for the service registered by the user based on the user account and the service identifier.

Operation 105: A bus card reader initiates a second registration request to the bus service server.

In some embodiments, the bus card reader may be the first electronic device 200. The bus card reader may initiate the second registration request to the bus service server, to complete registration of the bus card reader with the bus service server. The second registration request may carry a device number of the bus card reader.

It may be understood that the second registration request may further include information such as an IP address and a MAC address of the bus card reader, so that the bus service server may store the foregoing information, to complete the registration of the bus card reader with the bus service server. The information such as the device number, the IP address, and the MAC address is used for verification when the bus card reader is connected to the bus service server after being powered on. The second registration request may further include other information. This is not limited in this embodiment of this application.

Operation 106: The bus service server completes the registration of the bus card reader with the bus service server, and sends registration success information to the bus card reader.

Operation 107: The bus card reader switches to a Wi-Fi ultra-short distance mode.

In some embodiments, the Wi-Fi ultra-short distance mode is an ultra-short distance broadcast mode using a Wi-Fi function. The bus card reader may broadcast a service message within a particular distance or adjust a broadcast distance of a service message by using the Wi-Fi ultra-short distance mode. It may be understood that, the Wi-Fi ultra-short distance mode is a function mode in the Wi-Fi function, and a Wi-Fi broadcast distance may be controlled by adjusting a Wi-Fi antenna quantity or adjusting a Wi-Fi transmit power. For example, if the Wi-Fi antenna quantity or the Wi-Fi transmit power is reduced, the Wi-Fi broadcast distance may be reduced. The Wi-Fi broadcast distance may correspond to the Wi-Fi antenna quantity or the Wi-Fi transmit power. In other words, after the Wi-Fi antenna quantity or the Wi-Fi transmit power is determined, the Wi-Fi broadcast distance may be determined accordingly. During implementation, a switching function of the Wi-Fi ultra-short distance mode may be set in the bus card reader. The bus card reader switches to the Wi-Fi ultra-short distance mode, so that the Wi-Fi ultra-short distance broadcast function can be enabled in the bus card reader. For example, the user may enable a switch of the Wi-Fi ultra-short distance mode in the bus card reader, so that the bus card reader switches to the Wi-Fi ultra-short distance mode. When receiving an operation of enabling the Wi-Fi ultra-short distance mode by the user, the bus card reader may switch from a current mode to the Wi-Fi ultra-short distance mode. For example, if a current wireless communication mode of the bus card reader is a mode A, after the bus card reader switches to the Wi-Fi ultra-short distance mode, the bus card reader may switch from the mode A to the Wi-Fi ultra-short distance mode. It may be understood that, when receiving an operation of disabling the Wi-Fi ultra-short distance mode by the user, the bus card reader may switch from the Wi-Fi ultra-short distance mode to a mode used by the bus card reader before switching to the Wi-Fi ultra-short distance mode. For example, if a wireless communication mode used by the bus card reader before switching to the Wi-Fi ultra-short distance mode is a mode A, the bus card reader switches to the mode A after the Wi-Fi ultra-short distance mode is disabled.

The Wi-Fi ultra-short distance mode is described with reference to FIG. 2A. FIG. 2A is a schematic structural diagram of a bus card reader 1000. As shown in FIG. 2A, the bus card reader 1000 includes a microcontroller unit (MCU) 1001, a wireless communication module 1002, a strong antenna 1003, and a weak antenna 1004. The MCU 1001 may include a central processing unit, a memory, a counter, a clock, an interrupt, a serial peripheral interface (SPI), a UART interface, a universal serial bus interface, and the like. The UART interface is a universal serial data bus, and is configured to perform asynchronous communication. The bus may be a two-way communication bus, and converts to-be-transmitted data between serial communication and parallel communication. In some embodiments, the MCU 1001 exchanges information with the wireless communication module 1002 through the UART interface. The wireless communication module 1002 is configured to send or receive a radio signal. For example, the bus card reader 1000 may broadcast the foregoing service information (for example, bus payment service information) through the wireless communication module 1002.

The strong antenna 1003 and the weak antenna 1004 are configured to transmit and receive an electromagnetic wave. Further, the wireless communication module 1002 converts an electromagnetic wave received from the strong antenna 1003 or the weak antenna 1004 into a signal, and sends the signal to the MCU 1001 for processing; or the wireless communication module 1002 receives a to-be-sent signal from the MCU 1001, and converts the signal into an electromagnetic wave through the strong antenna 1003 or the weak antenna 1004 for radiation. The strong antenna 1003 and the weak antenna 1004 may each include one or more antennas. A transmitting distance for transmitting a radio signal by using the strong antenna 1003 is greater than a transmitting distance for transmitting a radio signal by using the weak antenna 1004. Further, switching may be performed between the strong antenna 1003 and the weak antenna 1004. For example, the MCU 1001 may control the switching between the strong antenna 1003 and the weak antenna 1004.

For example, a working mode of the weak antenna 1004 may be set to the Wi-Fi ultra-short distance mode. When the bus card reader 1000 uses the strong antenna 1003, the transmitting distance of the strong antenna 1003 may be used to transmit the wireless signal; or when the bus card reader 1000 uses the weak antenna 1004, the transmitting distance of the weak antenna 1004 may be used to transmit the wireless signal. The transmitting distance of the strong antenna 1003 and the transmitting distance of the weak antenna 1004 may be usually preset during initialization of the bus card reader 1000. The transmitting distance of the strong antenna 1003 may be set to a distance within a range of dozens of centimeters to several meters. The transmitting distance of the weak antenna 1004 may be set to a distance within a range of several centimeters to dozens of centimeters. It may be understood that the schematic structural diagram of FIG. 2A merely shows an implementation of the Wi-Fi ultra-short distance mode as an example. The Wi-Fi ultra-short distance mode may alternatively be implemented by using another hardware structure. This is not limited in this embodiment of this application.

Operation 108: The bus card reader broadcasts bus payment service information.

In some embodiments, the bus card reader may broadcast the bus payment service information by using the Wi-Fi ultra-short distance mode. The bus payment service information may be broadcast based on the preset broadcast distance in the Wi-Fi ultra-short distance mode. The bus payment service information may include a service identifier. The service identifier may be for identifying a bus payment service that can be provided by the bus card reader. For example, the bus card reader may provide a bus card swiping service.

In addition, the user may further adjust the broadcast distance in the bus card reader. During implementation, Wi-Fi signal strength may be changed by adjusting the Wi-Fi antenna quantity or the Wi-Fi transmit power, so that the broadcast distance of the bus payment service information can be controlled. For example, the user may adjust (for example, increase or decrease) the Wi-Fi signal strength on a display interface of the bus card reader. Alternatively, the user may adjust the Wi-Fi signal strength by using a button (for example, a Wi-Fi signal strength adjustment button) of the bus card reader. This is not limited in this embodiment of this application. The bus card reader receives the operation of adjusting the Wi-Fi signal strength by the user, and updates the Wi-Fi signal strength, to change a broadcast range of the bus card reader. For example, signal strength before increase may broadcast information within a particular distance (for example, a radius of 25 cm), and signal strength after increase may broadcast information within a particular distance (for example, a radius of 30 cm). In this way, only a mobile terminal within the foregoing distance can receive the bus payment service information broadcast by the bus card reader. The broadcast distance of the bus card reader is changed, so that security can be improved, and a misoperation caused when the mobile terminal approaches the bus card reader can be avoided.

It may be understood that the bus payment service information broadcast by the bus card reader may be simultaneously sent to the plurality of mobile terminals (for example, the mobile terminal 101 and the mobile terminal 102).

Operation 109: The mobile terminal enables a Wi-Fi function.

In some embodiments, the user may enable the Wi-Fi function in the mobile terminal. For example, the user may enable a Wi-Fi option in the mobile terminal, so that the mobile terminal enables the Wi-Fi function.

It should be noted that, because the bus card reader continuously broadcasts the bus payment service information, after enabling the Wi-Fi function, the mobile terminal may receive the bus payment service information broadcast by the bus card reader. In addition, operation 109 may alternatively be performed before operation 108. This is not limited in this embodiment of this application.

Operation 110: The one or more mobile terminals receive the bus payment service information broadcast by the bus card reader, and send a bus payment service subscription request to the bus card reader.

In some embodiments, the one or more mobile terminals may listen, by using the Wi-Fi function, to the bus payment service information broadcast by the bus card reader. For example, if any mobile terminal is within a range of the Wi-Fi signal strength of the bus card reader, the mobile terminal may listen to the bus payment service information broadcast by the bus card reader. After the mobile terminal receives the bus payment service information broadcast by the bus card reader, the mobile terminal may set up a Wi-Fi connection to the bus card reader, and send the bus payment service subscription request to the bus card reader based on the bus payment service information (for example, the service identifier). The bus payment service subscription request may include the user account and a mobile terminal device number. The service subscription request may be generated based on the foregoing service information.

It should be noted that the bus card reader continuously broadcasts the bus payment service information, in other words, the bus payment service information is broadcast for a plurality of times. Therefore, after the user enables the Wi-Fi function of the mobile terminal at any moment, the mobile terminal may receive the bus payment service information broadcast by the bus card reader. In addition, after receiving any bus payment service information, the mobile terminal may trigger a service process. For example, the mobile terminal may send the service subscription request to the bus card reader. In other words, after entering the service process, the mobile terminal does not process other received bus payment service information.

It may be understood that each bus payment service subscription request corresponds to each mobile terminal. For example, the mobile terminal 101 generates a bus payment service subscription request 101, and the mobile terminal 102 generates a bus payment service subscription request 102. The bus payment service subscription request 101 may include a user account 101 and a mobile terminal device number 101, and the bus payment service subscription request 102 may include a user account 102 and a mobile terminal device number 102.

Operation 111: After receiving the bus payment service subscription request sent by the one or more mobile terminals, the bus card reader sends a first message to the bus service server.

In some embodiments, after receiving the bus payment service subscription request of the one or more mobile terminals, the bus card reader sends the first message to the bus service server. In this way, the bus service server may perform identity verification on the user account based on the bus payment service subscription request in the first message. The first message includes the bus payment service subscription request.

It may be understood that the bus card reader may simultaneously receive bus payment service subscription requests sent by a plurality of mobile terminals. For example, the bus card reader may simultaneously receive bus payment service subscription requests of the mobile terminal 101 and the mobile terminal 102. Then, the bus card reader may generate a first message corresponding to the bus payment service subscription request of the mobile terminal 101 and a first message corresponding to the bus payment service subscription request of the mobile terminal 102; and send the first message corresponding to the mobile terminal 101 and the first message corresponding to the mobile terminal 102 to the bus service server, or sequentially send the first message corresponding to the mobile terminal 101 and the first message corresponding to the mobile terminal 102 to the bus service server. This is not limited in this embodiment of this application. In some embodiments, the bus card reader may alternatively generate a first message including bus payment service subscription requests of a plurality of mobile terminals. In other words, the first message may include the bus payment service subscription requests of the plurality of mobile terminals. For example, one first message may include both a bus payment service subscription request of the mobile terminal 101 and a bus payment service subscription request of the mobile terminal 102. This is not limited in this embodiment of this application.

Operation 112: The bus service server receives the first message sent by the bus card reader, performs the identity verification on the user account in the first message, and feeds back a third message to the bus card reader.

In some embodiments, after receiving the first message sent by the bus card reader, the bus service server obtains the user account in the first message, and compares the user account with a user account stored in the bus service server, to determine whether the user initiating the bus payment service subscription request this time has completed registration with the bus service server. In other words, the bus service server may determine, based on the user account, whether the registration of the user is completed. For example, the bus service server may query account information of the user in local storage. If the local storage includes account information consistent with that of the user initiating the bus payment service subscription request this time, the bus service server may consider that the identity verification of the user succeeds; or if the local storage does not include account information consistent with that of the user initiating the bus payment service subscription request this time, the bus service server may consider that the identity verification of the user fails.

After obtaining an identity verification result (for example, the verification succeeds or the verification fails), the bus service server feeds back the third message to the bus card reader, where the third message may include a notification message and the mobile terminal device number. For example, if the verification succeeds, the bus service server may send the third message to the bus card reader, to notify the bus card reader that the mobile terminal can initiate the current bus payment service, where the third message includes a confirmation notification and the mobile terminal device number; or if the verification fails, the bus service server may send the third message to the bus card reader, to notify the bus card reader that initiation of the current bus payment service by the mobile terminal is rejected, where the third message includes a failure notification and the mobile terminal device number.

It may be understood that the bus service server may generate a corresponding third message based on a quantity of mobile terminal device numbers in the first message. In other words, the bus service server may send a plurality of third messages to the bus card reader, where each third message corresponds to a mobile terminal device number. For example, if the mobile terminal device number in third information corresponds to the mobile terminal 101, the third message may be considered as a third message 101; or if the mobile terminal device number in the third message corresponds to the mobile terminal 102, the third message may be considered as a third message 102. The bus service server may alternatively generate one third message. In other words, the bus service server sends one third message to the bus card reader. The third message may include mobile terminal device numbers of a plurality of mobile terminals and notification messages. For example, one third message may include both a mobile terminal device number of the mobile terminal 101 and a notification message and a mobile terminal device number of the mobile terminal 102 and a notification message. This is not limited in this embodiment of this application.

Operation 113: The bus card reader receives the third message sent by the bus service server, and sends the notification message to the one or more mobile terminals based on the mobile terminal device number in the third message.

In some embodiments, the bus card reader receives the third message sent by the bus service server, obtains the mobile terminal device number in the third message, and may send the notification message to the mobile terminal based on the mobile terminal device number. The notification message may include a confirmation notification or a failure notification. For example, the mobile terminal 101 and the mobile terminal 102 are used as an example. The bus card reader receives two third messages, namely, the third message 101 of the mobile terminal 101 and the third message 102 of the mobile terminal 102, where the third message 101 includes a device number of the mobile terminal 101 and a notification message 101, and the third message 102 includes a device number of the mobile terminal 102 and a notification message 102. In this case, the notification message 101 may be sent to the mobile terminal 101 based on the device number of the mobile terminal 101, and the notification message 102 may be sent to the mobile terminal 102 based on the device number of the mobile terminal 102.

During implementation, after the bus card reader receives the third message sent by the bus service server, if the bus card reader determines that the third message includes the confirmation notification, in other words, the identity verification result of the user indicates that the identity verification succeeds, the bus card reader may send a confirmation notification message to the one or more mobile terminals, to notify the mobile terminals that the subscription to the bus payment service succeeds and the mobile terminals can initiate the current bus payment service; or

if the bus card reader determines that the third message includes the failure notification, in other words, the identity verification result of the user indicates that the identity verification fails, the bus card reader may send a failure notification message to the one or more mobile terminals, to notify the mobile terminals that the subscription to the bus payment service fails and the initiation of the current bus payment service by the mobile terminals is rejected.

Operation 114: The one or more mobile terminals receive the notification message sent by the bus card reader, and initiate a bus payment service request to the bus card reader.

In some embodiments, if the one or more mobile terminals receive the notification message sent by the bus card reader, the notification message may be determined.

If the notification message is the confirmation notification, the mobile terminal may initiate the bus payment service request to the bus card reader. For example, the mobile terminal may send the bus payment service request to the bus card reader, to initiate a current bus card swiping task. The bus payment service request may include the user account and the mobile terminal device number.

The mobile terminal has enabled the one-step payment function in operation 103. Therefore, when a screen are turned off, the mobile terminal may send the user account and the mobile terminal device number to the bus card reader, to complete the current bus card swiping task, so that the user can perform an insensible operation. For example, confirmation may be completed in a screen-off state of the mobile terminal. This simplifies the operation of the user, and can improve operation experience of the user.

If the notification message is the failure notification, the mobile terminal may end the current bus payment service.

Operation 115: After receiving the bus payment service request sent by the one or more mobile terminals, the bus card reader sends a second message to the bus service server.

In some embodiments, the bus card reader may simultaneously receive the bus payment service request sent by the one or more mobile terminals (for example, the mobile terminal 101 and the mobile terminal 102), and send the second message to the bus service server, where the second message includes the bus payment service request. For example, the bus card reader may sequentially send a second message corresponding to the mobile terminal 101 and a second message corresponding to the mobile terminal 102 to the bus service server, or may simultaneously send a second message corresponding to the mobile terminal 101 and a second message corresponding to the mobile terminal 102 to the bus service server. This is not limited in this embodiment of this application.

Operation 116: The bus service server receives the second message sent by the bus card reader, and processes the bus payment service request in the second message.

In some embodiments, after receiving the second message sent by the bus card reader, the bus service server may obtain the user account in the second message, obtain, through querying, corresponding payment information based on the user account, and complete automatic deduction based on a one-step payment protocol enabled by the user, to complete the current bus payment service of the user.

Operation 117: The bus service server sends a fourth message to the bus card reader.

In some embodiments, after completing processing of the bus payment service, the bus service server may further send the fourth message to the bus card reader. The fourth message may include a service processing completion notification and the mobile terminal device number. The service processing completion notification is for notifying the bus card reader that the user corresponding to the mobile terminal device number has completed the current bus deduction.

Operation 118: The bus card reader receives the fourth message sent by the bus service server, and sends the service processing completion notification to the one or more mobile terminals.

In some embodiments, after receiving the fourth message sent by the bus service server, the bus card reader may obtain the service processing completion notification and the mobile terminal device number that are in the fourth message, and send the service processing completion notification to the corresponding mobile terminal based on the mobile terminal device number, to give a prompt that the user corresponding to the mobile terminal device number has completed the current bus deduction.

Operation 119: The bus card reader gives a prompt of the completed bus payment service.

In some embodiments, after receiving the service processing completion notification sent by the bus service server, the bus card reader may give a prompt to the merchant that the current bus deduction is completed. For example, the bus card reader may display information about the service processing completion notification on a display screen. For example, the information about the service processing completion notification may be prompt information such as information indicating that payment is completed. The bus card reader alternatively gives a prompt by using a sound. This is not limited in this embodiment of this application.

Operation 119 may be performed simultaneously with operation 118, or may be performed after operation 118, or may be performed before operation 118. This is not limited in this embodiment of this application.

In this embodiment, the one or more mobile terminals simultaneously initiate the bus payment service to the bus card reader, so that efficiency of processing the bus payment service by the bus card reader can be improved. In addition, the user can complete the bus payment service in the screen-off state, so that operation experience of the user can be improved.

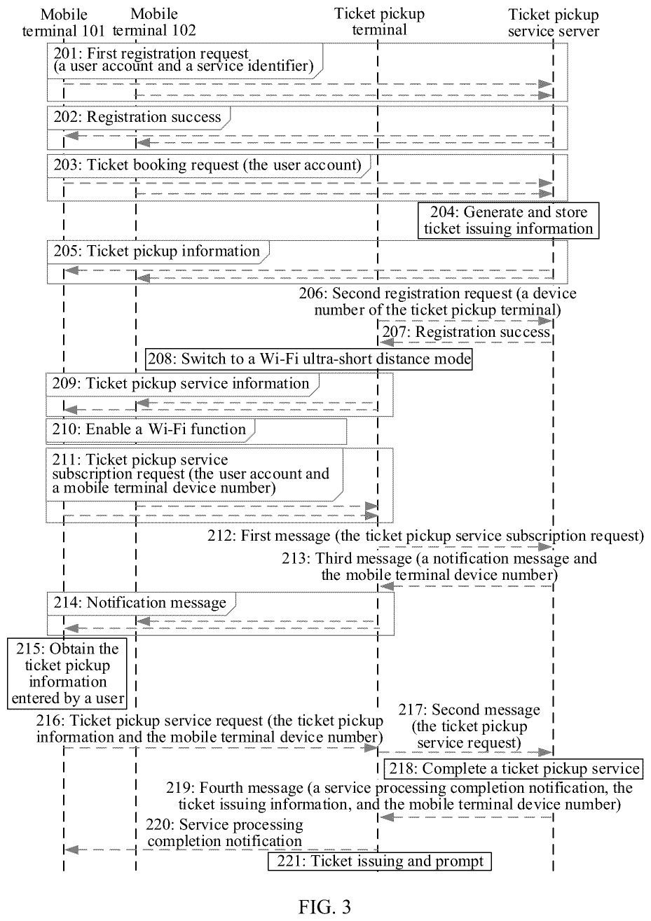

Next, a ticket pickup service scenario is used as an example for description. FIG. 3 is a schematic flowchart of another embodiment of a service processing method according to this application. The method may include the following operations.

Operation 201: One or more mobile terminals send a first registration request to a ticket pickup service server, to complete registration of a ticket pickup service of a user.

In some embodiments, the ticket pickup service server may be the second electronic device 300. The user may send the first registration request to the ticket pickup service server through the mobile terminal, to request, from the ticket pickup service server, the registration of the ticket pickup service. The first registration request includes a user account and a service identifier. The user account is for identifying an identity of the user. The service identifier is for identifying the registered service.

Operation 202: The ticket pickup service server sends a registration success message to the one or more mobile terminals.

In some embodiments, after receiving the first registration request of the one or more mobile terminals, the ticket pickup service server may store the user account and the service identifier that are in the first registration request sent by the one or more mobile terminals, and send the registration success message to the one or more mobile terminals, so that the one or more mobile terminals can complete a task of registering the ticket pickup service with the ticket pickup service server.

Operation 203: The one or more mobile terminals send a ticket booking request to the ticket pickup service server.

In some embodiments, any mobile terminal may send the ticket booking request to the ticket pickup service server, to complete ticket booking, where the ticket booking request may include the user account. For example, the user may log in to the mobile terminal by using the user account, and book a ticket by using the user account.

It may be understood that the ticket pickup service server may include a ticket booking service and a ticket pickup service. In other words, the ticket pickup service server may complete a ticket booking request and a ticket pickup request of the user.

Operation 204: The ticket pickup service server generates ticket issuing information based on the ticket booking request, and stores the ticket issuing information.

In some embodiments, after receiving the ticket booking request of the one or more mobile terminals, the ticket pickup service server generates the ticket issuing information corresponding to the ticket booking request. For example, the ticket issuing information may include information such as the user account, a user name, a show time, a train number, and time. It may be understood that each piece of ticket issuing information may be in a one-to-one correspondence with each user account. During implementation, the ticket pickup service server may generate a corresponding verification code based on the ticket issuing information. The verification code may include a digital code or a QR code, or may be a verification code in another form. This is not limited in this embodiment of this application. Then, the ticket pickup service server may further store the verification code.

Operation 205: The ticket pickup service server sends ticket pickup information to the one or more mobile terminals.

In some embodiments, the ticket pickup service server may send the ticket pickup information to the corresponding mobile terminal, where the ticket pickup information may include the verification code.

Operation 206: A ticket pickup terminal initiates a second registration request to the ticket pickup service server.

In some embodiments, the ticket pickup terminal may be the first electronic device 200. The ticket pickup terminal may initiate the second registration request to the ticket pickup service server, to complete registration of the ticket pickup terminal with the ticket pickup service server. The second registration request may carry a device number of the ticket pickup terminal.

It may be understood that the second registration request may further include information such as an IP address and a MAC address of the ticket pickup terminal, so that the ticket pickup service server may store the foregoing information, to complete registration of the ticket pickup terminal with the bus service server. The information such as the device number, the IP address, and the MAC address is used for verification when the ticket pickup terminal is connected to the ticket pickup service server after being powered on. The second registration request may further include other information. This is not limited in this embodiment of this application.

Operation 207: The ticket pickup service server sends registration success information to the ticket pickup terminal, to complete the registration of the ticket pickup terminal with the ticket pickup service server.

Operation 208: The ticket pickup terminal switches to a Wi-Fi ultra-short distance mode.

In some embodiments, a switching function of the Wi-Fi ultra-short distance mode may be set in the ticket pickup terminal. The ticket pickup terminal switches to the Wi-Fi ultra-short distance mode, so that a Wi-Fi ultra-short distance broadcast function can be enabled in the ticket pickup terminal. For example, the user may enable a switch of the Wi-Fi ultra-short distance mode in the ticket pickup terminal, so that the ticket pickup terminal switches to the Wi-Fi ultra-short distance mode. When receiving an operation of enabling the Wi-Fi ultra-short distance mode by the user, the ticket pickup terminal may switch from a current mode to the Wi-Fi ultra-short distance mode.

Operation 209: The ticket pickup terminal broadcasts ticket pickup service information.

In some embodiments, the ticket pickup terminal may broadcast the ticket pickup service information by using the Wi-Fi ultra-short distance mode. The ticket pickup service information may include a service identifier, and the service identifier may be for identifying a ticket pickup service that can be provided by the ticket pickup terminal. For example, the ticket pickup terminal may provide a ticket pickup service like an air ticket, a train ticket, a movie ticket, or a bus ticket.

In addition, the user may further adjust Wi-Fi signal strength in the ticket pickup terminal, to control a broadcast distance of the ticket pickup service information. For example, the user may adjust (for example, increase or decrease) the Wi-Fi signal strength on a display interface of the ticket pickup terminal. Alternatively, the user may adjust the Wi-Fi signal strength by using a button (for example, a Wi-Fi signal strength adjustment button) of the ticket pickup terminal. This is not limited in this embodiment of this application. The ticket pickup terminal receives the operation of adjusting the Wi-Fi signal strength by the user, and updates the Wi-Fi signal strength, to change a broadcast range of the ticket pickup terminal. For example, signal strength before increase may broadcast information within a particular distance (for example, a radius of 25 cm), and signal strength after increase may broadcast information within a particular distance (for example, a radius of 30 cm). In this way, only a mobile terminal within the foregoing distance can receive the ticket pickup service information broadcast by the ticket pickup terminal. The broadcast distance of the ticket pickup terminal is changed, so that security can be improved, and a misoperation caused when the mobile terminal approaches the ticket pickup terminal can be avoided.

Operation 210: The mobile terminal enables a Wi-Fi function.

In some embodiments, the user may enable the Wi-Fi function in the mobile terminal. For example, the user may enable a Wi-Fi option in the mobile terminal, so that the mobile terminal enables the Wi-Fi function.

It should be noted that, because the ticket pickup terminal continuously broadcasts the ticket pickup service information, after enabling the Wi-Fi function, the mobile terminal may receive the ticket pickup service information broadcast by the ticket pickup terminal. In addition, operation 207 may alternatively be performed before operation 206. This is not limited in this embodiment of this application.

Operation 211: The one or more mobile terminals receive the ticket pickup service information broadcast by the ticket pickup terminal, and send a first message to the ticket pickup terminal.

In some embodiments, the one or more mobile terminals may listen, by using the Wi-Fi function, to the ticket pickup service information broadcast by the ticket pickup terminal. For example, if any mobile terminal is within a range of the Wi-Fi signal strength of the ticket pickup terminal, the mobile terminal may listen to the ticket pickup service information broadcast by the ticket pickup terminal. After the mobile terminal receives the ticket pickup service information broadcast by the ticket pickup terminal, the mobile terminal may set up a Wi-Fi connection to the ticket pickup terminal, and send a ticket pickup service subscription request to the ticket pickup terminal based on the ticket pickup service information (for example, the service identifier). The ticket pickup service subscription request may include the user account and a mobile terminal device number.

It may be understood that each ticket pickup service subscription request corresponds to a mobile terminal. For example, a mobile terminal 101 generates a ticket pickup service subscription request 101, and a mobile terminal 102 generates a ticket pickup service subscription request 102. The ticket pickup service subscription request 101 may include a user account 101 and a mobile terminal device number 101, and the ticket pickup service subscription request 102 may include a user account 102 and a mobile terminal device number 102.

Operation 212: After receiving the ticket pickup service subscription request sent by the one or more mobile terminals, the ticket pickup terminal sends the first message to the ticket pickup service server.

In some embodiments, after receiving the ticket pickup service subscription request of the one or more mobile terminals, the ticket pickup terminal sends the first message to the ticket pickup service server. In this way, the ticket pickup service server may perform identity verification on the user account based on the first message. The first message includes the ticket pickup service subscription request.

Operation 213: The ticket pickup service server receives the first message sent by the ticket pickup terminal, performs the identity verification on the user account in the first message, and feeds back a third message to the ticket pickup terminal.

In some embodiments, after receiving the first message sent by the ticket pickup terminal, the ticket pickup service server obtains the user account in the first message, and compares the user account with a user account stored in the ticket pickup service server, to determine whether the user initiating the ticket pickup service subscription request this time has completed registration with the ticket pickup service server. In other words, the ticket pickup service server may determine, based on the user account, whether the registration of the user is completed. For example, the ticket pickup service server may query account information of the user in local storage. If the local storage includes account information consistent with that of the user initiating the ticket pickup service subscription request this time, the ticket pickup service server may consider that the identity verification of the user succeeds; or if the local storage does not include account information consistent with that of the user initiating the ticket pickup service subscription request this time, the ticket pickup service server may consider that the identity verification of the user fails.

After obtaining an identity verification result (for example, the verification succeeds or the verification fails), the ticket pickup service server feeds back the identity verification result to the ticket pickup terminal. For example, if the verification succeeds, the ticket pickup service server may send the third message to the ticket pickup terminal, to notify the ticket pickup terminal that the mobile terminal can initiate the current ticket pickup service, where the third message includes a confirmation notification and the mobile terminal device number; or if the verification fails, the ticket pickup service server may send the third message to the ticket pickup terminal, to notify the ticket pickup terminal that initiation of the current ticket pickup service by the mobile terminal is rejected, where the third message includes a failure notification and the mobile terminal device number.

Operation 214: The ticket pickup terminal receives the third message sent by the ticket pickup service server, and sends a notification message to the one or more mobile terminals based on the mobile terminal device number in the third message.

In some embodiments, the ticket pickup terminal receives the third message sent by the ticket pickup service server, obtains the mobile terminal device number in the third message, and may send the notification message to the mobile terminal based on the mobile terminal device number. The notification message may include a confirmation notification or a failure notification. For example, the mobile terminal 101 and the mobile terminal 102 are used as an example. The ticket pickup terminal receives two third messages, namely, a third message 101 of the mobile terminal 101 and a third message 102 of the mobile terminal 102, where the third message 101 includes a device number of the mobile terminal 101 and a notification message 101, and the third message 102 includes a device number of the mobile terminal 102 and a notification message 102. In this case, the notification message 101 may be sent to the mobile terminal 101 based on the device number of the mobile terminal 101, and the notification message 102 may be sent to the mobile terminal 102 based on the device number of the mobile terminal 102.

During implementation, after the ticket pickup terminal receives the third message sent by the ticket pickup service server, if the ticket pickup terminal determines that the third message includes the confirmation notification, in other words, the identity verification result of the user indicates that the identity verification succeeds, the ticket pickup terminal may send a confirmation notification message to the one or more mobile terminals, to notify the mobile terminals that the subscription to the ticket pickup service succeeds and the mobile terminals can initiate the current ticket pickup service; or

if the ticket pickup terminal determines that the third message includes the failure notification, in other words, the identity verification result of the user indicates that the identity verification fails, the ticket pickup terminal may send a failure notification message to the one or more mobile terminals, to notify the mobile terminals that the subscription to the ticket pickup service fails and initiation of the current ticket pickup service by the mobile terminals is rejected.

Operation 215: In response to an operation of entering the ticket pickup information by the user, obtain the ticket pickup information entered by the user.

In some embodiments, the mobile terminal 101 is used as an example. After receiving a fourth message that includes the confirmation notification and that is sent by the ticket pickup terminal, the mobile terminal 101 may display, on a display screen of the mobile terminal 101, an interface for entering the ticket pickup information. For example, the user may perform an operation on the display interface of the mobile terminal, to enter the ticket pickup information. The ticket pickup information may be information such as a ticket pickup number code and a ticket pickup two-dimensional code. The information such as the ticket pickup number code and the ticket pickup QR code may be delivered by the ticket pickup service server to the mobile terminal 101 in advance. This is not limited in this embodiment of this application. The user can enter the corresponding ticket pickup information on the interface.

It may be understood that, after receiving a fourth message that includes a confirmation notification and that is sent by the ticket pickup terminal, another mobile terminal (for example, the mobile terminal 102) may also perform a operation like that of the mobile terminal 101. For example, a user may also enter corresponding ticket pickup information on an interface of the mobile terminal 102.

Operation 216: The mobile terminals send a ticket pickup service request to the ticket pickup terminal.

In some embodiments, the mobile terminal 101 is used as an example. The mobile terminal 101 may send the ticket pickup service request to the ticket pickup terminal. The ticket pickup service request is for requesting the ticket pickup terminal to issue a ticket, and may include the ticket pickup information in the mobile terminal 101 and the device number of the mobile terminal 101.

It may be understood that, after obtaining ticket pickup information entered by the user, another mobile terminal (for example, the mobile terminal 102) may also perform a operation like that of the mobile terminal 101. For example, the mobile terminal 102 may also send a ticket pickup service request to the ticket pickup terminal. The ticket pickup service request may include ticket pickup information in the mobile terminal 102 and the device number of the mobile terminal 102.

Operation 217: After receiving the ticket pickup service request sent by the one or more mobile terminals, the ticket pickup terminal sends second information to the ticket pickup service server.

In some embodiments, the ticket pickup terminal may simultaneously receive the ticket pickup service request sent by the one or more mobile terminals (for example, the mobile terminal 101 and the mobile terminal 102), and send the second message to the ticket pickup service server, where the second message includes the ticket pickup service request. For example, the ticket pickup terminal may sequentially send a second message corresponding to the mobile terminal 101 and a second message corresponding to the mobile terminal 102 to the ticket pickup service server, or may simultaneously send a second message corresponding to the mobile terminal 101 and a second message corresponding to the mobile terminal 102 to the ticket pickup service server. This is not limited in this embodiment of this application.

Operation 218: The ticket pickup service server receives the second message sent by the ticket pickup terminal, and processes the ticket pickup service request in the second message.

In some embodiments, after receiving the second message sent by the ticket pickup terminal, the ticket pickup service server may obtain the ticket pickup information in the second message, and obtain, through querying, the corresponding ticket issuing information based on the ticket pickup information. For example, the ticket issuing information may include information such as the user account, a user name, a show time of a movie ticket, a train number of a train ticket, or a flight and time of a plane ticket.

Operation 219: The ticket pickup service server sends a fourth message to the ticket pickup terminal.

In some embodiments, after completing processing of the ticket pickup service, the ticket pickup service server may further send the fourth message to the ticket pickup terminal. The fourth message may include a service processing completion notification, the ticket issuing information, and the mobile terminal device number. The service processing completion notification is for notifying the ticket pickup terminal that the user corresponding to the mobile terminal device number has completed processing of a current ticket issuing service. The ticket issuing information may be used by the ticket pickup terminal for printing, to complete ticket issuing.

Operation 220: The ticket pickup terminal sends the service processing completion notification to the one or more mobile terminals.

In some embodiments, after receiving the fourth message sent by the ticket pickup service server, the ticket pickup terminal may obtain the service processing completion notification and the mobile terminal device number that are in the fourth message, and send the service processing completion notification to the corresponding mobile terminal based on the mobile terminal device number, to give a prompt that the user corresponding to the mobile terminal device number has completed the current ticket issuing service.

Operation 221: The ticket pickup terminal completes ticket issuing, and gives a prompt that the current ticket issuing service is completed.

In some embodiments, after receiving the service processing completion notification and the ticket issuing information that are sent by the ticket pickup service server, the ticket pickup terminal may print and issue the ticket based on the ticket issuing information. For example, the ticket pickup terminal may print an air ticket, a train ticket, a movie ticket, a bus ticket, and the like based on information such as a train number, a show time, a flight, and time in the ticket issuing information, to complete ticket issuing, and display, on a display screen of the ticket pickup terminal after the printing is completed, prompt information such as information indicating that the ticket is issued. In some embodiments, when the ticket is printed and issued, the user account may be further printed on the ticket. This is not limited in this embodiment of this application.

Operation 221 may be performed simultaneously with operation 220, or may be performed after operation 220, or may be performed before operation 220. This is not limited in this embodiment of this application.

In this embodiment, the one or more mobile terminals simultaneously initiate the ticket pickup service to the ticket pickup terminal, so that processing efficiency of the ticket pickup service can be improved.

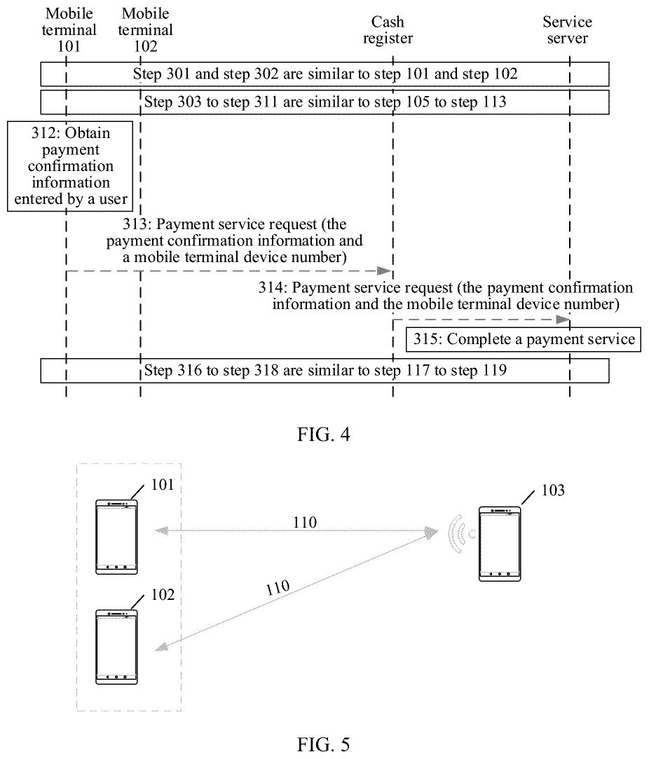

Next, another payment service is as an example for description. FIG. 4 is a schematic flowchart of still another embodiment of a service processing method according to this application. The method may include operation 301 to operation 318.

Operation 301 and operation 302 are similar to operation 101 and operation 102. For details, refer to operation 101 and operation 102 in the foregoing embodiment. Details are not described herein again.

Operation 303 to operation 311 are similar to operation 105 to operation 113. For details, refer to operation 105 to operation 113 in the foregoing embodiment. Details are not described herein again.

Operation 312: In response to an operation of entering payment confirmation information by a user, obtain the payment confirmation information entered by the user.

In some embodiments, a mobile terminal 101 is used as an example. After receiving a confirmation notification message sent by a cashing register, the mobile terminal 101 may display, on a display screen of the mobile terminal 101, an interface for entering the payment confirmation information. For example, the user may perform an operation on the interface of the mobile terminal 101, to enter the payment confirmation information. The payment confirmation information may be transaction information. For example, the transaction information may include information such as a current transaction order number, a transaction amount, a transaction channel, and a transaction password. This is not limited in this embodiment of this application. The user can enter the corresponding payment confirmation information on the interface.

It may be understood that, after receiving a confirmation notification message sent by the cashing register, another mobile terminal (for example, a mobile terminal 102) may also perform a operation like that of the mobile terminal 101. For example, a user may also enter corresponding payment confirmation information on an interface of the mobile terminal 102.

Operation 313: The one or more mobile terminals send a payment service request to the cashing register.

In some embodiments, the mobile terminal 101 is used as an example. The mobile terminal 101 may send the payment service request to the cashing register. The payment service request is for initiating payment to the cashing register, and may include the payment confirmation information and a device number of the mobile terminal 101.

It may be understood that, after obtaining payment confirmation information entered by a user, another mobile terminal (for example, the mobile terminal 102) may also perform a operation like that of the mobile terminal 101. For example, the mobile terminal 102 may also send a payment service request to the cashing register. The payment service request may include the payment confirmation information in the mobile terminal 102 and a device number of the mobile terminal 102.

Operation 314: After receiving the payment service request sent by the one or more mobile terminals, the cashing register forwards the payment service request to a service server.

Operation 315: The service server receives the payment service request sent by the cashing register, and processes the payment service request.

In some embodiments, after receiving the payment service request sent by the cashing register, the service server may obtain the payment confirmation information in the payment service request, obtain, through querying, a corresponding deduction account based on the payment confirmation information, and then perform deduction from the deduction account based on the transaction password in the payment confirmation information, to complete a current payment service.

Operation 316 to operation 318 are similar to operation 117 to operation 119. For details, refer to operation 117 to operation 119 in the foregoing embodiment. Details are not described herein again.

In this embodiment, the users enter transaction information to complete transaction services of the plurality of users, so that service processing efficiency can be improved, and user experience can be improved.

FIG. 5 is an architectural diagram of another embodiment of an application scenario of a service processing method according to this application. The application scenario may be a data sharing scenario. In the data sharing scenario, data sharing may be performed between a plurality of mobile terminals. As shown in FIG. 5, a mobile terminal 101 and a mobile terminal 102 perform data sharing with a mobile terminal 103 by using a Wi-Fi ultra-short distance mode 110. The mobile terminal 101 and the mobile terminal 102 are data sharing receivers, and the mobile terminal 103 is a data sharing sender. It may be understood that FIG. 5 merely shows two data sharing receivers as an example, but allows more data sharing receivers. This is not limited in this embodiment of this application.

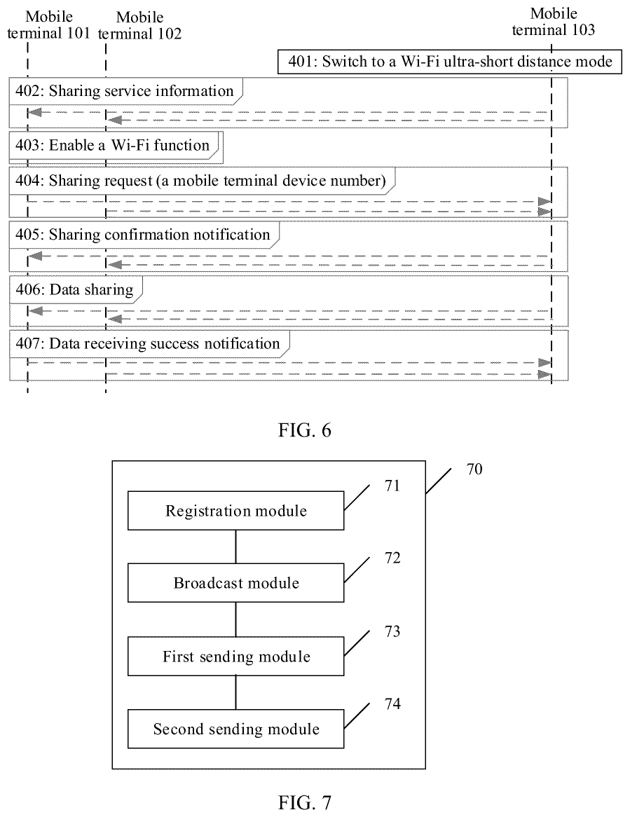

FIG. 6 is a schematic flowchart of still another embodiment of a service processing method according to this application. The method may include the following operations.

Operation 401: A mobile terminal 103 switches to a Wi-Fi ultra-short distance mode.

In some embodiments, the mobile terminal 103 may be considered as a data sharing sender. Therefore, a user may switch a wireless communication mode to the Wi-Fi ultra-short distance mode on the mobile terminal 103, so that the mobile terminal 103 may broadcast service information by using the Wi-Fi ultra-short distance mode.

Operation 402: The mobile terminal 103 broadcasts sharing service information.

In some embodiments, the user may perform an operation on the mobile terminal 103, to enable a data sharing service of the mobile terminal 103. For example, the user may enable a data sharing switch in the mobile terminal 103. In response to the operation of the user, the mobile terminal 103 may broadcast the sharing service information by using the Wi-Fi ultra-short distance mode, to notify a surrounding mobile terminal (for example, a mobile terminal 101 or a mobile terminal 102) that the mobile terminal 103 can provide the data sharing service. It may be understood that the user may alternatively enable the data sharing service of the mobile terminal 103 by performing another operation. This is not limited in this embodiment of this application. The data sharing service may include a text transmission service, an image transmission service, a song transmission service, and the like, or may include another type of sharing service. This is not limited in this embodiment of this application.

It should be noted that, for setting of a distance for broadcasting the sharing service information by the mobile terminal 103, refer to operation 108. Details are not described herein again.

Operation 403: The mobile terminal 101 and the mobile terminal 102 enable Wi-Fi functions.

In some embodiments, the mobile terminal 101 and the mobile terminal 102 may be considered as data sharing receivers.

It may be understood that more mobile terminals may be used as data sharing receivers. This is not limited in this embodiment of this application.

Operation 404: The mobile terminal 101 and the mobile terminal 102 receive the sharing service information broadcast by the mobile terminal 103, and send sharing requests to the mobile terminal 103.

In some embodiments, the mobile terminal 101 and the mobile terminal 102 may approach the mobile terminal 103, to receive the sharing service information broadcast by the mobile terminal 103. After the mobile terminal 101 and the mobile terminal 102 receive the sharing service information, the mobile terminal 101 and the mobile terminal 102 may initiate the sharing requests to the mobile terminal 103. The sharing requests may include identity information of the mobile terminal 101 and the mobile terminal 102 (for example, device numbers of the mobile terminal 101 and the mobile terminal 102). For example, the sharing request 101 of the mobile terminal 101 may include the device number of the mobile terminal 101, and the sharing request 102 of the mobile terminal 102 may include the device number of the mobile terminal 102.

Operation 405: The mobile terminal 103 receives the sharing requests sent by the mobile terminal 101 and the mobile terminal 102, and sends sharing confirmation notifications to the mobile terminal 101 and the mobile terminal 102.

In some embodiments, the mobile terminal 103 receives the sharing requests sent by the mobile terminal 101 and the mobile terminal 102, obtains the mobile terminal device numbers in the sharing requests, and may send the sharing confirmation notifications to the mobile terminal 101 and the mobile terminal 102 based on the mobile terminal device numbers and establish data transmission channels with the mobile terminal 101 and the mobile terminal 102, so that the mobile terminal 101 and the mobile terminal 102 can receive shared data sent by the mobile terminal 103.

Operation 406: The mobile terminal 103 transmits the shared data to the mobile terminal 101 and the mobile terminal 102.

In some embodiments, the shared data may be data preset by the user. For example, the user may preset the shared data in the mobile terminal 103. For example, the shared data may include data such as music, a text, a movie, and an image, or may include other types of shared data. This is not limited in this embodiment of this application. After the mobile terminal 103 sets up Wi-Fi connections to the mobile terminal 101 and the mobile terminal 102, the mobile terminal 103 may transmit the shared data to the mobile terminal 101 and the mobile terminal 102.

In some embodiments, in a process of sending the shared data to the mobile terminal 101 and the mobile terminal 102, the mobile terminal 103 may further display, based on a total data amount of the shared data, current progress of sending the shared data.

Operation 407: The mobile terminal 101 and the mobile terminal 102 receive the shared data transmitted by the mobile terminal 103, and feed back data receiving success notifications to the mobile terminal 103.

In some embodiments, the mobile terminal 101 and the mobile terminal 102 receive the shared data transmitted by the mobile terminal 103. After completing receiving of the shared data, the mobile terminal 101 or the mobile terminal 102 may feed back the data receiving success notification to the mobile terminal 103, to notify the mobile terminal 103 that the current receiving of shared data is completed.

In some embodiments, in a process of receiving the shared data transmitted by the mobile terminal 103, the mobile terminal 101 and the mobile terminal 102 may further display, based on a total data amount of the shared data, current progress of receiving the shared data.

In some embodiments, the shared data may include a plurality of files, and the mobile terminal 103 may send the plurality of files in a plurality of times. Therefore, each time the mobile terminal 101 and the mobile terminal 102 each receive a file in the shared data, the mobile terminal 101 and the mobile terminal 102 may feed back data receiving success notifications to the mobile terminal 103.

In this embodiment, one mobile terminal simultaneously shares data with a plurality of other mobile terminals by using the Wi-Fi ultra-short distance mode. This can improve flexibility of data sharing, and improve efficiency of data sharing.

FIG. 7 is a schematic structural diagram of an embodiment of a service processing apparatus according to this application. As shown in FIG. 7, the service processing apparatus 70 is applied to an electronic device, and may include a registration module 71, a broadcast module 72, a first sending module 73, and a second sending module 74.

The registration module 71 is configured to register, by the electronic device, with a server.

The broadcast module 72 is configured to broadcast service information to one or more mobile terminals based on a preset broadcast distance.

The first sending module 73 is configured to: receive a service subscription request sent by the one or more mobile terminals, where the service subscription request is generated based on the service information; and send a first message to the server, where the first message includes the service subscription request, and the first message indicates the server to confirm the service subscription request.

The second sending module 74 is configured to: receive a service request sent by the one or more mobile terminals; and send a second message to the server based on the service request, where the second message indicates the server to perform service processing.

In a possible implementation, the apparatus 70 further includes a third sending module 75.

The third sending module 75 is configured to receive: a third message sent by the server, where the third message includes a subscription confirmation notification; and send the subscription confirmation notification to the one or more mobile terminals.

In a possible implementation, the apparatus 70 further includes a prompting module 76.

The prompting module 76 is configured to: receive a fourth message sent by the server; and give a prompt based on the fourth message, where the fourth message includes a service processing completion notification.

In a possible implementation, the apparatus 70 further includes a fourth sending module 77.

The fourth sending module 77 is configured to send the service processing completion notification to the one or more mobile terminals.

In a possible implementation, the service request includes ticket pickup information, and the second sending module 74 is further configured to: the second message indicates the server to perform verification based on the ticket pickup information and perform the service processing based on a verification result.

In a possible implementation, the apparatus 70 further includes a ticket issuing module 78.

The ticket issuing module 78 is configured to: receive a fourth message sent by the server, where the fourth message includes ticket issuing information; and issue a ticket based on the fourth message.

In a possible implementation, the electronic device is a payee device or a ticket pickup device.

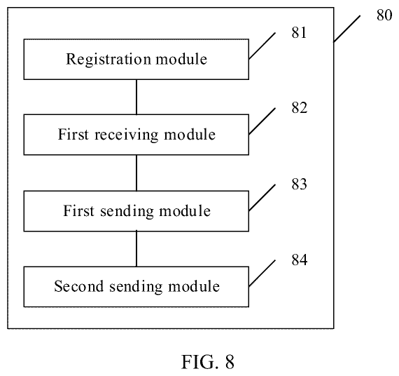

FIG. 8 is a schematic structural diagram of another embodiment of a service processing apparatus according to this application. As shown in FIG. 8, the service processing apparatus 80 is applied to a mobile terminal, and may include a registration module 81, a first receiving module 82, a first sending module 83, and a second sending module 84.

The registration module 81 is configured to register, by the mobile terminal, with a server.

The first receiving module 82 is configured to: enable, by the mobile terminal, a Wi-Fi function; and receive service information broadcast by an electronic device.

The first sending module 83 is configured to: generate a service subscription request based on the service information; and send the service subscription request to the electronic device, where the service subscription request indicates the server to confirm a service subscribed by a user.

The second sending module 84 is configured to send a service request to the electronic device, where the service request indicates the server to perform service processing.

In a possible implementation, the registration module 81 includes a first sending unit 811 and a second sending unit 81.

The first sending unit 811 is configured to send, by the mobile terminal, a first registration request to the server, where the first registration request includes a user account and payment information.

The second sending unit 812 is configured to send, by the mobile terminal, a payment service request to the server, where the payment service request is for requesting to enable a one-step payment function for the user account.

In a possible implementation, the second sending module 84 is further configured to: the service request indicates the server to complete payment based on information about the user account in the server.

In a possible implementation, the registration module 81 includes a first sending unit 811.

The first sending unit 811 is configured to send, by the mobile terminal, a first registration request to the server, where the first registration request includes a user account and payment information.

In a possible implementation, the second sending module 84 is further configured to: obtain payment confirmation information entered by the user; and send the service request to the electronic device, where the service request includes the payment confirmation information, and the service request indicates the server to perform the service processing based on the payment confirmation information.

In a possible implementation, the second sending module 84 is further configured to: obtain ticket pickup information entered by the user; and send the service request to the electronic device, where the service request includes the ticket pickup information, and the service request indicates the server to perform the service processing based on the ticket pickup information.

In a possible implementation, the apparatus 80 further includes a second receiving module 85.

The second receiving module 85 is configured to receive a subscription confirmation notification sent by the electronic device, where the subscription confirmation notification indicates the mobile terminal to send the service request.

In a possible implementation, the apparatus 80 further includes a third receiving module 86.

The third receiving module 86 is configured to receive a service processing completion notification sent by the electronic device, where the service processing completion notification is for giving a prompt to the user that the service processing is completed.

It should be understood that division into the foregoing modules of the service processing apparatus shown in FIG. 7 and FIG. 8 is merely logical function division. During actual implementation, all or some of the modules may be integrated into one physical entity, or may be physically separated. In addition, all of the modules may be implemented in a form of software invoked by using a processing element or may be implemented in a form of hardware. Alternatively, some modules may be implemented in a form of software invoked by using a processing element, and some modules are implemented in a form of hardware. For example, a detection module may be a separately disposed processing element, or may be integrated into a chip of an electronic device for implementation. Implementations of other modules are similar to the implementation of the detection module. In addition, all or some of the modules may be integrated together, or may be implemented independently. In an implementation process, operations in the foregoing method or the foregoing modules may be implemented by using a hardware integrated logical circuit in the processing element, or by using instructions in a form of software.

For example, the foregoing modules may be one or more integrated circuits configured to implement the foregoing method, for example, one or more application-specific integrated circuits (ASICs), one or more microprocessors or digital signal processors (DSPs), or one or more field programmable gate arrays (FPGAs). For another example, the modules may be integrated together, and implemented in a form of a system-on-a-chip (SOC).

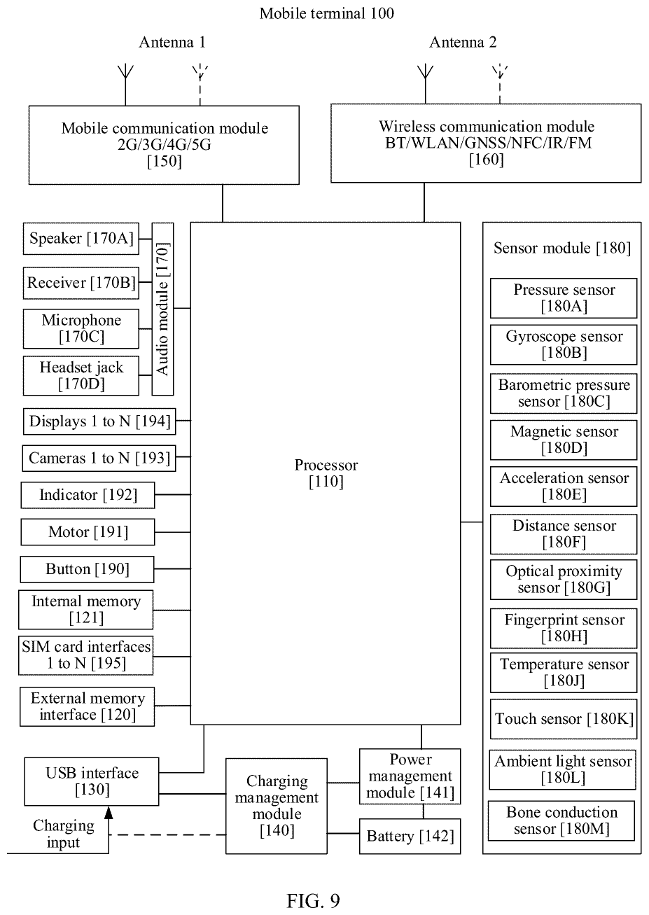

FIG. 9 is a schematic structural diagram of a mobile terminal 100. The mobile terminal 100 may be the mobile terminal 101 or the mobile terminal 102.

The mobile terminal 100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of the present invention does not constitute a limitation on the mobile terminal 100. In some other embodiments of this application, the mobile terminal 100 may include more or fewer components than those shown in the figure, or combine some components, or split some components, or have different component arrangements. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a DSP, a baseband processor, a neural-network processing unit (NPU), and/or the like. Different processing units may be independent components, or may be integrated into one or more processors.

The controller may generate an operation control signal based on instruction operation code and a time sequence signal, to complete control of instruction reading and instruction execution.

A memory may be further disposed in the processor 110, and is configured to store instructions and data. In some embodiments, the memory in the processor 110 is a cache memory. The memory may store instructions or data that has been used or cyclically used by the processor 110. If the processor 110 needs to use the instructions or the data again, the processor may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a SIM interface, a USB interface, and/or the like.

The I2C interface is a two-way synchronization serial bus, and includes one serial data line (SDA) and one serial clock line (SCL). In some embodiments, the processor 110 may include a plurality of groups of I2C buses. The processor 110 may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the mobile terminal 100.

The I2S interface may be used to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transmit an audio signal to the wireless communication module 160 through the I2S interface, to implement a function of answering a call through a Bluetooth headset.

The PCM interface may also be used to perform audio communication, and sample, quantize, and code an analog signal. In some embodiments, the audio module 170 may be coupled to the wireless communication module 160 through a PCM bus interface. In some embodiments, the audio module 170 may transmit an audio signal to the wireless communication module 160 through the PCM interface alternatively, to implement a function of answering a call through a Bluetooth headset. Both the I2S interface and the PCM interface may be used for audio communication.

The UART interface is a universal serial data bus, and is configured to perform asynchronous communication. The bus may be a two-way communication bus. The bus converts to-be-transmitted data between serial communication and parallel communication. In some embodiments, the UART interface is usually configured to connect the processor 110 to the wireless communication module 160. For example, the processor 110 communicates with a Bluetooth module in the wireless communication module 160 through the UART interface, to implement a Bluetooth function. In some embodiments, the audio module 170 may transmit an audio signal to the wireless communication module 160 through the UART interface, to implement a function of playing music through a Bluetooth headset.

The MIPI interface may be configured to connect the processor 110 to a peripheral component like the display 194 or the camera 193. The MIPI interface includes a camera serial interface (CSI), a display serial interface (DSI), and the like. In some embodiments, the processor 110 communicates with the camera 193 through the CSI interface, to implement a photographing function of the mobile terminal 100. The processor 110 communicates with the display 194 through the DSI interface, to implement a display function of the mobile terminal 100.

The GPIO interface may be configured by software. The GPIO interface may be configured as a control signal or a data signal. In some embodiments, the GPIO interface may be configured to connect the processor 110 to the camera 193, the display 194, the wireless communication module 160, the audio module 170, the sensor module 180, or the like. The GPIO interface may alternatively be configured as an I2C interface, an I2S interface, a UART interface, an MIPI interface, or the like.

The USB interface 130 is an interface that conforms to a USB standard specification, and may be specifically a mini USB interface, a micro USB interface, a USB type-C interface, or the like. The USB interface 130 may be configured to: connect to a charger to charge the mobile terminal 100; transmit data between the mobile terminal 100 and a peripheral device; or connect to a headset for playing audio through the headset. The interface may be further configured to connect to another electronic device like an AR device.

It may be understood that an interface connection relationship between the modules shown in this embodiment of the present invention is merely an example for description, and does not constitute a structural limitation on the mobile terminal 100. In some other embodiments of this application, the mobile terminal 100 may alternatively use an interface connection manner different from that in the foregoing embodiment, or a combination of a plurality of interface connection manners.

The charging management module 140 is configured to receive a charging input from the charger. The charger may be a wireless charger or a wired charger. In some embodiments of wired charging, the charging management module 140 may receive a charging input of a wired charger through the USB interface 130. In some embodiments of wireless charging, the charging management module 140 may receive a wireless charging input by using a wireless charging coil of the mobile terminal 100. The charging management module 140 supplies power to the electronic device through the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like. The power management module 141 may be further configured to monitor parameters such as a battery capacity, a battery cycle count, and a battery state of health (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the mobile terminal 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the mobile terminal 100 may be configured to cover one or more communication frequency bands. Different antennas may further be multiplexed, to improve antenna utilization. For example, the antenna 1 may be multiplexed as a diversity antenna of a wireless local area network. In some other embodiments, an antenna may be used in combination with a tuning switch.

The mobile communication module 150 may provide a wireless communication solution that includes 2G, 3G, 4G, 5G, or the like and that is applied to the mobile terminal 100. The mobile communication module 150 may include at least one filter, a switch, a power amplifier, a low noise amplifier (LNA), and the like. The mobile communication module 150 may receive an electromagnetic wave through the antenna 1, perform processing such as filtering or amplification on the received electromagnetic wave, and transmit the processed electromagnetic wave to the modem processor for demodulation. The mobile communication module 150 may further amplify a signal modulated by the modem processor, and convert the signal into an electromagnetic wave through the antenna 1 for radiation. In some embodiments, at least some functional modules of the mobile communication module 150 may be disposed in the processor 110. In some embodiments, at least some functional modules of the mobile communication module 150 and at least some modules of the processor 110 may be disposed in a same device.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (which is not limited to the speaker 170A, the receiver 170B, or the like), or displays an image or a video through the display 194. In some embodiments, the modem processor may be an independent component. In some other embodiments, the modem processor may be independent of the processor 110, and is disposed in a same device as the mobile communication module 150 or another functional module.

The wireless communication module 160 may provide a wireless communication solution that is applied to the mobile terminal 100 and that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like. The wireless communication module 160 may be one or more devices that integrate at least one communication processing module. The wireless communication module 160 receives an electromagnetic wave through the antenna 2, performs frequency modulation and filtering processing on the electromagnetic wave signal, and sends the processed signal to the processor 110. The wireless communication module 160 may further receive a to-be-sent signal from the processor 110, perform frequency modulation and amplification on the signal, and convert the signal into an electromagnetic wave through the antenna 2 for radiation.

In some embodiments, in the mobile terminal 100, the antenna 1 is coupled to the mobile communication module 150, and the antenna 2 is coupled to the wireless communication module 160, so that the mobile terminal 100 can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The mobile terminal 100 implements a display function by using the GPU, the display 194, the application processor, and the like. The GPU is a microprocessor for image processing, and is connected to the display 194 and the application processor. The GPU is configured to: perform mathematical and geometric computation; and render an image. The processor 110 may include one or more GPUs that execute program instructions to generate or change display information.

The display 194 is configured to display an image, a video, and the like. The display 194 includes a display panel. The display panel may be a liquid crystal display (LCD), an organic light-emitting diode (OLED), an active-matrix organic light emitting diode (AMOLED), a flexible light-emitting diode (FLED), a mini-LED, a micro-LED, a micro-OLED, a quantum dot light emitting diode (QLED), or the like. In some embodiments, the mobile terminal 100 may include one or N displays 194, where N is a positive integer greater than 1.

The mobile terminal 100 may implement a photographing function through the ISP, the camera 193, the video codec, the GPU, the display 194, the application processor, and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 193.

The camera 193 is configured to capture a static image or a video. An optical image of an object is generated through the lens, and is projected onto the photosensitive element. The photosensitive element may be a charge-coupled device (CCD) or a complementary metal-oxide-semiconductor (CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format like RGB or YUV. In some embodiments, the mobile terminal 100 may include one or N cameras 193, where N is a positive integer greater than 1.

The digital signal processor is configured to process a digital signal, and may process another digital signal in addition to the digital image signal. For example, when the mobile terminal 100 selects a frequency, the digital signal processor is configured to perform Fourier transform and the like on frequency energy.

The video codec is configured to compress or decompress a digital video. The mobile terminal 100 may support one or more video codecs. In this way, the mobile terminal 100 may play or record videos in a plurality of coding formats, for example, moving picture experts group (MPEG)-1, MPEG-2, MPEG-3, and MPEG-4.

The NPU is a neural-network (NN) computation processor. The NPU quickly processes input information by referring to a structure of a biological neural network, for example, by referring to a mode of transmission between human brain neurons, and continuously performs self-learning. The mobile terminal 100 may implement applications such as intelligent cognition through the NPU, for example, image recognition, facial recognition, speech recognition, and text understanding.

The external memory interface 120 may be configured to connect to an external memory card like a Micro SD card, to extend a storage capability of the mobile terminal 100. The external memory card communicates with the processor 110 through the external memory interface 120, to implement a data storage function. For example, files such as music and videos are stored in the external storage card.

The internal memory 121 may be configured to store computer-executable program code. The executable program code includes instructions. The internal memory 121 may include a program storage area and a data storage area. The program storage area may store an operating system, an application required by at least one function (for example, a voice playing function or an image playing function), and the like. The data storage area may store data (for example, audio data or a phone book) created in a process of using the mobile terminal 100. In addition, the internal memory 121 may include a high-speed random access memory, or may include a nonvolatile memory, for example, at least one magnetic disk storage device, a flash memory, or a universal flash storage (UFS). The processor 110 executes various functional applications and data processing of the mobile terminal 100 by running the instructions stored in the internal memory 121 and/or the instructions stored in the memory disposed in the processor.

The mobile terminal 100 may implement audio functions such as music playing and recording through the audio module 170, the speaker 170A, the receiver 170B, the microphone 170C, the headset jack 170D, the application processor, and the like.

The audio module 170 is configured to convert digital audio information into an analog audio signal for output, and is also configured to convert analog audio input into a digital audio signal. The audio module 170 may be further configured to code and decode an audio signal. In some embodiments, the audio module 170 may be disposed in the processor 110, or some functional modules in the audio module 170 are disposed in the processor 110.

The speaker 170A, also referred to as a “loudspeaker”, is configured to convert an electrical audio signal into a sound signal. The mobile terminal 100 may listen to music or answer a hands-free call through the speaker 170A.

The receiver 170B, also referred to as an “earpiece”, is configured to convert an electrical audio signal into a sound signal. When a call is answered or a voice message is received by using the mobile terminal 100, the receiver 170B may be placed near a human ear to listen to a voice.

The microphone 170C, also referred to as a “mike” or a “mic”, is configured to convert a sound signal into an electrical signal. When making a call or sending a voice message, a user may make a sound near the microphone 170C through the mouth of the user, to input a sound signal to the microphone 170C. At least one microphone 170C may be disposed in the mobile terminal 100. In some other embodiments, two microphones 170C may be disposed in the mobile terminal 100, to collect a sound signal and further implement a noise reduction function. In some other embodiments, three, four, or more microphones 170C may be disposed in the mobile terminal 100, to collect a sound signal, reduce noise, identify a sound source, implement a directional recording function, and the like.

The headset jack 170D is configured to connect to a wired headset. The headset jack 170D may be a USB interface 130, or may be a 3.5 mm open mobile electronic device platform (OMTP) standard interface or cellular telecommunications industry association of the USA (CTIA) standard interface.

The pressure sensor 180A is configured to sense a pressure signal, and can convert the pressure signal into an electrical signal. In some embodiments, the pressure sensor 180A may be disposed on the display 194. There are a plurality of types of pressure sensors 180A, such as a resistive pressure sensor, an inductive pressure sensor, and a capacitive pressure sensor. The capacitive pressure sensor may include at least two parallel plates made of conductive materials. When a force is applied to the pressure sensor 180A, capacitance between electrodes changes. The mobile terminal 100 determines pressure strength based on a change of the capacitance. When a touch operation is performed on the display 194, the mobile terminal 100 detects intensity of the touch operation based on the pressure sensor 180A. The mobile terminal 100 may also calculate a touch location based on a detection signal of the pressure sensor 180A. In some embodiments, touch operations that are performed in a same touch position but have different touch operation intensity may correspond to different operation instructions. For example, when a touch operation whose touch operation intensity is less than a first pressure threshold is performed on an SMS message application icon, an instruction for viewing an SMS message is performed. When a touch operation whose touch operation intensity is greater than or equal to the first pressure threshold is performed on the SMS message application icon, an instruction for creating a new SMS message is performed.

The gyroscope sensor 180B may be configured to determine a motion posture of the mobile terminal 100. In some embodiments, an angular velocity of the mobile terminal 100 around three axes (namely, axes x, y, and z) may be determined through the gyroscope sensor 180B. The gyroscope sensor 180B may be configured to implement image stabilization during photographing. For example, when the shutter is pressed, the gyroscope sensor 180B detects an angle at which the mobile terminal 100 shakes, and calculates, based on the angle, a distance for which a lens module needs to compensate, so that the lens cancels the shake of the mobile terminal 100 through reverse motion, thereby implementing the image stabilization. The gyroscope sensor 180B may also be used in a navigation scenario and a somatic game scenario.

The barometric pressure sensor 180C is configured to measure barometric pressure. In some embodiments, the mobile terminal 100 calculates an altitude by using a barometric pressure value measured by the barometric pressure sensor 180C, to assist in positioning and navigation.

The magnetic sensor 180D includes a Hall sensor. The mobile terminal 100 may detect opening and closing of a flip cover by using the magnetic sensor 180D. In some embodiments, when the mobile terminal 100 is a flip phone, the mobile terminal 100 may detect opening and closing of a flip cover by using the magnetic sensor 180D, and then set, based on a detected opening or closing state of the leather case or a detected opening or closing state of the flip cover, a feature likes automatic unlocking of the flip cover.

The acceleration sensor 180E may detect values of accelerations in various directions (usually on three axes) of the mobile terminal 100. When the mobile terminal 100 is still, a magnitude and a direction of gravity may be detected. The acceleration sensor 180E may be further configured to identify a posture of the electronic device, and is used in an application like switching between a landscape mode and a portrait mode or a pedometer.

The distance sensor 180F is configured to measure a distance. The mobile terminal 100 may measure a distance in an infrared or a laser manner. In some embodiments, in a photographing scenario, the mobile terminal 100 may measure a distance by using the range sensor 180F, to implement quick focusing.

The optical proximity sensor 180G may include, for example, a light-emitting diode (LED) and an optical detector, for example, a photodiode. The light-emitting diode may be an infrared light-emitting diode. The mobile terminal 100 emits infrared light by using the light-emitting diode. The mobile terminal 100 detects, by using the photodiode, infrared reflected light that comes from a nearby object. When detecting sufficient reflected light, the mobile terminal 100 may determine that there is an object near the mobile terminal 100. When detecting insufficient reflected light, the mobile terminal 100 may determine that there is no object near the mobile terminal 100. The mobile terminal 100 may detect, by using the optical proximity sensor 180G, that the user holds the mobile terminal 100 close to an ear for a call, to automatically perform screen-off to save power. The optical proximity sensor 180G may also be used in a smart cover mode or a pocket mode to automatically perform screen unlocking or locking.

The ambient light sensor 180L is configured to sense ambient light brightness. The mobile terminal 100 may adaptively adjust brightness of the display 194 based on the sensed ambient light brightness. The ambient light sensor 180L may also be configured to automatically adjust white balance during photographing. The ambient light sensor 180L may further cooperate with the optical proximity sensor 180G to detect whether the mobile terminal 100 is in a pocket, to prevent an accidental touch.

The fingerprint sensor 180H is configured to collect a fingerprint. The mobile terminal 100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the mobile terminal 100 executes a temperature processing policy based on the temperature detected by the temperature sensor 180J. For example, when the temperature reported by the temperature sensor 180J exceeds a threshold, the mobile terminal 100 degrades performance of a processor near the temperature sensor 180J, to reduce power consumption and implement thermal protection. In some other embodiments, when the temperature is less than another threshold, the mobile terminal 100 heats up the battery 142, to avoid abnormal shutdown of the mobile terminal 100 due to a low temperature. In some other embodiments, when the temperature is less than still another threshold, the mobile terminal 100 boosts an output voltage of the battery 142, to avoid abnormal shutdown due to a low temperature.

The touch sensor 180K is also referred to as a “touch component”. The touch sensor 180K may be disposed on the display 194, and the touch sensor 180K and the display 194 constitute a touchscreen, which is also referred to as a “touch screen”. The touch sensor 180K is configured to detect a touch operation performed on or near the touch sensor 180K. The touch sensor may transfer the detected touch operation to the application processor to determine a type of the touch event. A visual output related to the touch operation may be provided through the display 194. In some other embodiments, the touch sensor 180K may alternatively be disposed on a surface of the mobile terminal 100 at a location different from that of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a body pulse to receive a blood pressure beating signal. In some embodiments, the bone conduction sensor 180M may also be disposed in the headset, to obtain a bone conduction headset. The audio module 170 may obtain a speech signal through parsing based on the vibration signal that is of the vibration bone of the vocal-cord part and that is obtained by the bone conduction sensor 180M, to implement a speech function. The application processor may parse heart rate information based on the blood pressure beating signal obtained by the bone conduction sensor 180M, to implement a heart rate detection function.

The button 190 includes a power button, a volume button, and the like. The button 190 may be a mechanical button, or may be a touch button. The mobile terminal 100 may receive a key input, and generate a key signal input related to user settings and function control of the mobile terminal 100.

The motor 191 may generate a vibration prompt. The motor 191 may be configured to provide an incoming call vibration prompt and a touch vibration feedback. For example, touch operations performed on different applications (for example, photographing and audio playback) may correspond to different vibration feedback effects. The motor 191 may also correspond to different vibration feedback effects for touch operations performed on different areas of the display 194. Different application scenarios (for example, a time reminder, information receiving, an alarm clock, and a game) may also correspond to different vibration feedback effects. A touch vibration feedback effect may be further customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the mobile terminal 100. The mobile terminal 100 may support one or N SIM card interfaces, where N is a positive integer greater than 1. The SIM card interface 195 may support a nano-SIM card, a micro-SIM card, a SIM card, and the like. A plurality of cards may be inserted into a same SIM card interface 195 at the same time. The plurality of cards may be of a same type or different types. The SIM card interface 195 may be compatible with different types of SIM cards. The SIM card interface 195 is also compatible with an external storage card. The mobile terminal 100 interacts with a network by using the SIM card, to implement functions such as calling and data communication. In some embodiments, the mobile terminal 100 uses an eSIM, namely, an embedded SIM card. The eSIM card may be embedded in the mobile terminal 100, and cannot be separated from the mobile terminal 100.

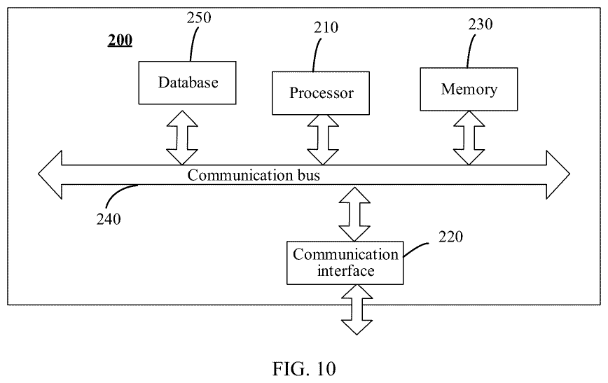

FIG. 10 is a schematic structural diagram of an embodiment of a first electronic device 200 according to this application. As shown in FIG. 10, the first electronic device 200 may be a data processing device, or may be a circuit device built in the data processing device. The first electronic device 200 may be configured to perform functions/operations in the methods provided in embodiments shown in FIG. 1 to FIG. 6 of this application.

As shown in FIG. 10, the first electronic device 200 is represented in a form of a general-purpose computing device.

The first electronic device 200 may include one or more processors 210, a communication interface 220, a memory 230, a communication bus 240 that connects different system components (including the memory 230 and the processor 210), a database 250, and one or more computer programs.

The one or more computer programs are stored in the memory. The one or more computer programs include instructions. When the instructions are executed by the first electronic device, the first electronic device is enabled to perform the following operations:
registering, by the electronic device, with a server;
broadcasting service information to one or more mobile terminals based on a preset broadcast distance;
receiving a service subscription request sent by the one or more mobile terminals, where the service subscription request is generated based on the service information;
sending a first message to the server, where the first message includes the service subscription request, and the first message indicates the server to confirm the service subscription request; and
receiving a service request sent by the one or more mobile terminals, and sending a second message to the server based on the service request, where the second message indicates the server to perform service processing.

In a possible implementation, when the instructions are executed by the first electronic device, the first electronic device is enabled to further perform, before performing the operation of receiving a service request sent by the one or more mobile terminals, the following operations:
receiving a third message sent by the server, where the third message includes a subscription confirmation notification; and
sending the subscription confirmation notification to the one or more mobile terminals.

In a possible implementation, when the instructions are executed by the first electronic device, the first electronic device is enabled to further perform, after performing the operation of sending a second message to the server based on the service request, the following operation:

receiving a fourth message sent by the server, and giving a prompt based on the fourth message, where the fourth message includes a service processing completion notification.

In a possible implementation, when the instructions are executed by the first electronic device, the first electronic device is enabled to further perform, after performing the operation of receiving a fourth message sent by the server, the following operation:

sending the service processing completion notification to the one or more mobile terminals.

In a possible implementation, the service request includes ticket pickup information; and when the instructions are executed by the first electronic device, the first electronic device is enabled to perform the operation in which the second message indicates the server to perform service processing, where the operation includes:

the second message indicates the server to perform verification based on the ticket pickup information and perform the service processing based on a verification result.

In a possible implementation, when the instructions are executed by the first electronic device, the first electronic device is enabled to further perform, after performing the operation of sending a second message to the server, the following operations:
receiving a fourth message sent by the server, where the fourth message includes ticket issuing information; and
issuing a ticket based on the fourth message.

In a possible implementation, the electronic device is a payee device or a ticket pickup device.

It may be understood that, an interface connection relationship between the modules shown in this embodiment of this application is merely an example for description, and does not constitute a structural limitation on the mobile terminal 100 and the first electronic device 200. In some other embodiments of this application, the mobile terminal 100 and the first electronic device 200 may alternatively use an interface connection manner different from that in the foregoing embodiment, or a combination of a plurality of interface connection manners.

It may be understood that, to implement the foregoing functions, the foregoing mobile terminal includes corresponding hardware structures and/or software modules for performing the functions. A person skilled in the art should be easily aware that, in combination with units and algorithm operations of the examples described in embodiments disclosed in this specification, embodiments of this application may be implemented by hardware or a combination of hardware and computer software. Whether a function is performed by hardware or hardware driven by computer software depends on a particular application and a design constraint of the technical solutions. A person skilled in the art may use different methods to implement the described functions for each particular application, but it should not be considered that the implementation goes beyond the scope of embodiments of this application.

In embodiments of this application, functional modules of the mobile terminal and the like may be obtained through division based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, division into the modules is an example, and is merely logical function division. During actual implementation, another division manner may be used.

The foregoing descriptions about the implementations allow a person skilled in the art to clearly understand that, for the purpose of convenient and brief description, division into the foregoing functional modules is used as an example for illustration. During actual application, the foregoing functions may be allocated to different functional modules for implementation based on a requirement, that is, an inner structure of an apparatus is divided into different functional modules to implement all or some of the foregoing functions. For a detailed working process of the foregoing system, apparatus, and unit, refer to a corresponding process in the foregoing method embodiments. Details are not described herein again.

Functional units in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of embodiments of this application essentially, or the part contributing to the conventional technology, or all or some of the technical solutions may be implemented in the form of a software product. The computer software product is stored in a storage medium and includes several instructions for instructing a computer device (which may be a personal computer, a server, or a network device) or a processor to perform all or some of the operations of the methods described in embodiments of this application. The foregoing storage medium includes: any medium that can store program code, like a flash memory, a removable hard disk, a read-only memory, a random access memory, a magnetic disk, or a compact disc.

The foregoing descriptions are merely example implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. An electronic device comprising,
a processor and a memory, wherein the processor is coupled to the memory, which is configured to store computer program code that includes executable instructions, and in response to the processor reading the executable instructions from the memory, the electronic device is configured to:
register with a server;
broadcast service information to one or more mobile terminals based on a preset broadcast distance;
receive a service subscription request sent by the one or more mobile terminals, wherein the service subscription request is generated based on the service information;
send a first message to the server, wherein the first message comprises the service subscription request, and the first message indicates the server to confirm the service subscription request; and
receive a service request sent by the one or more mobile terminals, and send a second message to the server based on the service request, wherein the second message indicates the server to perform service processing.

2. The electronic device according to claim 1, wherein the electronic device is further configured to:
receive a third message sent by the server, wherein the third message comprises a subscription confirmation notification; and
send the subscription confirmation notification to the one or more mobile terminals.

3. The electronic device according to claim 1, wherein the electronic device is further configured to:
receive a fourth message sent by the server, and give a prompt based on the fourth message, wherein the fourth message comprises a service processing completion notification.

4. The electronic device according to claim 1, wherein the electronic device is further configured to:
send the service processing completion notification to the one or more mobile terminals.

5. The electronic device according to claim 1, wherein the service request comprises ticket pickup information, and
wherein the second message indicates the server to perform verification based on the ticket pickup information and perform the service processing based on a verification result.

6. The electronic device according to claim 1, wherein the electronic device is further configured to:
receive a fourth message sent by the server, wherein the fourth message comprises ticket issuing information; and
issue a ticket based on the fourth message.

7. The electronic device according to claim 1, wherein the electronic device is a payee device or a ticket pickup device.

8. An electronic device, comprising:
a processor and a memory, wherein the processor is coupled to the memory which is configured to store computer program code that includes executable instructions, and in response to the processor reading the instructions from the memory, the electronic device is configured to:
register with a server;
enable a Wi-Fi function, and receive service information broadcast by a second electronic device;
generate a service subscription request based on the service information, and send the service subscription request to the second electronic device, wherein the service subscription request indicates the server to confirm a service subscribed by a user; and
send a service request to the electronic device, wherein the service request indicates the server to perform service processing.

9. The electronic device according to claim 8, wherein the electronic device is further configuring to:
send a first registration request to the server, wherein the first registration request comprises a user account and payment information; and
send a payment service request to the server, wherein the payment service request is for requesting to enable a one-step payment function for the user account.

10. The electronic device according to claim 8, wherein the service request indicates the server to complete payment based on information about the user account in the server.

11. The electronic device according to claim 8, wherein the electronic device is further configured to:
send a first registration request to the server, wherein the first registration request comprises a user account and payment information.

12. The electronic device according to claim 8, wherein the electronic device is further configured to:
obtain payment confirmation information entered by the user; and
send the service request to the second electronic device, wherein the service request comprises the payment confirmation information, and the service request indicates the server to perform the service processing based on the payment confirmation information.

13. The electronic device according to claim 8, wherein the electronic device is further configured to:
obtain ticket pickup information entered by the user; and
send the service request to the second electronic device, wherein the service request comprises the ticket pickup information, and the service request indicates the server to perform the service processing based on the ticket pickup information.

14. The electronic device according to claim 8, wherein the electronic device is further configured to:
receive a subscription confirmation notification sent by the second electronic device, wherein the subscription confirmation notification indicates the electronic device to send the service request.

15. The electronic device according to claim 8, wherein the electronic device is further configured to:
receive a service processing completion notification sent by the second electronic device, wherein the service processing completion notification is for giving a prompt to the user that the service processing is completed.

16.-18. (canceled)

19. A method comprising:
registering, at an electronic device, with a server;
broadcasting service information to one or more mobile terminals based on a preset broadcast distance;
receiving a service subscription request sent by the one or more mobile terminals, wherein the service subscription request is generated based on the service information;
sending a first message to the server, wherein the first message comprises the service subscription request, and the first message indicates the server to confirm the service subscription request; and
receiving a service request sent by the one or more mobile terminals, and sending a second message to the server based on the service request, wherein the second message indicates the server to perform service processing.

20. The method of claim 19, further comprising:
receiving a third message sent by the server, wherein the third message comprises a subscription confirmation notification; and
sending the subscription confirmation notification to the one or more mobile terminals.

21. The method of claim 19, further comprising:
receiving a fourth message sent by the server, and giving a prompt based on the fourth message, wherein the fourth message comprises a service processing completion notification.

22. The method of claim 19, further comprising:
sending the service processing completion notification to the one or more mobile terminals.

23. The method of claim 19, wherein the service request comprises ticket pickup information, and
wherein the second message indicates the server to perform verification based on the ticket pickup information and perform the service processing based on a verification result.
